(19) United States
(12) Patent Application Publication
(10) Pub. No.: US 2026/0262088 A1
(43) Pub. Date: Sep. 3, 2026

(54) COMMUNICATION DEVICE AND COMMUNICATION METHOD

(71) Applicant: NTT DOCOMO, INC., Tokyo (JP)

(72) Inventors: Daisuke KURITA, Tokyo (JP); Hiroki HARADA, Tokyo (JP); Weiqi SUN, Beijing (CN); Jing WANG, Beijing (CN); Lan CHEN, Beijing (CN)

(73) Assignee: NTT DOCOMO, INC., Tokyo (JP)

(21) Appl. No.: 19/100,234

(22) PCT Filed: Aug. 5, 2022
(86) PCT No.: PCT/JP2022/030145

§ 371 Date: Jan. 31, 2025

(51) Int. Cl. H04W 74/0816; H04W 74/00; H04W 76/28

(52) U.S. Cl. CPC H04W 74/0816; H04W 74/002; H04W 76/28

(57) ABSTRACT

This communication device comprises: a control unit that, when switching the state relating to a transfer operation executed between a base station and a terminal by the communication device to a first state, sets a specific period before a period of the first state, and switches said state to the first state; and a communication unit that transmits or receives a signal relating to the transfer in accordance with the first state.

### TECHNICAL FIELD

The present disclosure relates to a communication apparatus and a communication method.

### BACKGROUND ART

In Universal Mobile Telecommunication System (UMTS) networks, Long Term Evolution (LTE) has been specified with the aim of achieving higher data rates, lower latency, and other improvements. Future systems of LTE have also been studied for achieving a broader bandwidth and a higher speed based on LTE. Successor systems to LTE include, for example, systems referred to as LTE-Advanced (LTE-A), Future Radio Access (FRA), 5th generation mobile communication system (5G), 5G plus (5G+), Radio Access Technology (New-RAT), New Radio (NR), and the like.

Further, in NR, a communication apparatus (which may be referred to as a relay apparatus) that relays signals between a user terminal (User Equipment (UE), which may be simply referred to as a terminal) and a radio base station (which may be simply referred to as a base station) has been studied.

### CITATION LIST

### Non-Patent Literature

### NPL 1

3GPP TSG RAN WG1 #109-e, R1-2204534, Discussion on operation scenarios for NCR, May 9-20, 2022

### SUMMARY OF INVENTION

However, there is room for consideration regarding the appropriate control of the relay operation in a communication apparatus that performs relaying.

An aspect of the present disclosure provides a communication apparatus and a communication method capable of controlling an appropriate relay operation.

A communication apparatus according to an embodiment of the present disclosure includes: a control section that configures, in a case where a state related to a transfer operation executed by the communication apparatus between a base station and a terminal is switched to a first state, a specific period before a period of the first state, and switches the state to the first state; and a communication section that performs transmission or reception of a signal related to transfer in accordance with the first state.

A communication method according to an embodiment of the present disclosure includes: configuring, by a communication apparatus, in a case where a state related to a transfer operation executed by the communication apparatus between a base station and a terminal is switched to a first state, a specific period before a period of the first state, and switching the state to the first state; and performing, by the communication apparatus, transmission or reception of a signal related to transfer in accordance with the first state.

### BRIEF DESCRIPTION OF DRAWINGS

FIG. 1 is a diagram illustrating an exemplary radio communication system according to an embodiment of the present disclosure;

FIG. 2 is a diagram illustrating exemplary frequency ranges used in a radio communication system according to an embodiment of the present disclosure;

FIG. 3 is a diagram illustrating an exemplary configuration of a radio frame, a subframe, and a slot used in a radio communication system according to an embodiment of the present disclosure;

FIG. 4 is a diagram illustrating an exemplary configuration of NCR 300;

FIG. 5 is a diagram illustrating an example of the relationship between the side control information and the application time of ON;

FIG. 6 is a diagram illustrating an example of Proposal 1-1;

FIG. 7 is a diagram illustrating an example of the relationship between the side control information and the application time of OFF;

FIG. 8 is a diagram illustrating an example of Proposal 1-2;

FIG. 9 is a diagram illustrating examples of a continuous ON period and OFF period;

FIG. 10 is a diagram illustrating examples of a continuous OFF period and ON period;

FIG. 11 is a diagram illustrating examples of a non-continuous ON period and OFF period;

FIG. 12 is a diagram illustrating examples of a non-continuous OFF period and an ON period;

FIG. 13 is a diagram illustrating examples of an ON period, an OFF period, and a gap period;

FIG. 14 is a diagram illustrating examples of an ON period, an OFF period, and a gap period distinguished in a time unit;

FIG. 15 is a diagram illustrating examples of an ON period, an OFF period, and a gap period distinguished in a time unit;

FIG. 16 is a diagram illustrating examples of switching points;

FIG. 17 is a diagram illustrating an example of a pattern including a gap period;

FIG. 18 is a block diagram illustrating an exemplary configuration of a base station according to an embodiment of the present disclosure;

FIG. 19 is a block diagram illustrating an exemplary configuration of a terminal according to an embodiment of the present disclosure;

FIG. 20 is a block diagram illustrating an exemplary configuration of a relay apparatus according to an embodiment of the present disclosure;

FIG. 21 is a diagram illustrating an exemplary hardware configuration of a base station, a relay apparatus, and a terminal according to an embodiment of the present disclosure; and

FIG. 22 is a diagram illustrating an exemplary configuration of a vehicle.

### DESCRIPTION OF EMBODIMENTS

Hereinafter, an embodiment of the present disclosure will be described with reference to the drawings. Note that the embodiment described below are merely examples, and the embodiment to which the present disclosure is applied are not limited to the following embodiment.

Further, in the embodiment of the present disclosure described below, the terms such as Synchronization signal (SS), Primary SS (PSS), Secondary SS (SSS), Physical broadcast channel (PBCH), Physical random access channel (PRACH), Physical Downlink Control Channel (PDCCH), Physical Downlink Shared Channel (PDSCH), Physical Uplink Control Channel (PUCCH), Physical Uplink Shared Channel (PUSCH), and the like, which are used in 5G New Radio (NR), are used. This is for the sake of convenience in description, and the same signals, functions, and the like may be called by other names.

Further, in the embodiment of the present disclosure, the duplex method may be a Time Division Duplex (TDD) method, an Frequency Division Duplex (FDD) method, or another method (for example, a Flexible Duplex method).

Further, in the embodiment of the present disclosure, the phrase “a radio parameter or the like is “configured,”” may refer to pre-configuration of a predetermined value or configuration of a radio parameter that is indicated from a base station or a terminal.

### Radio Communication System

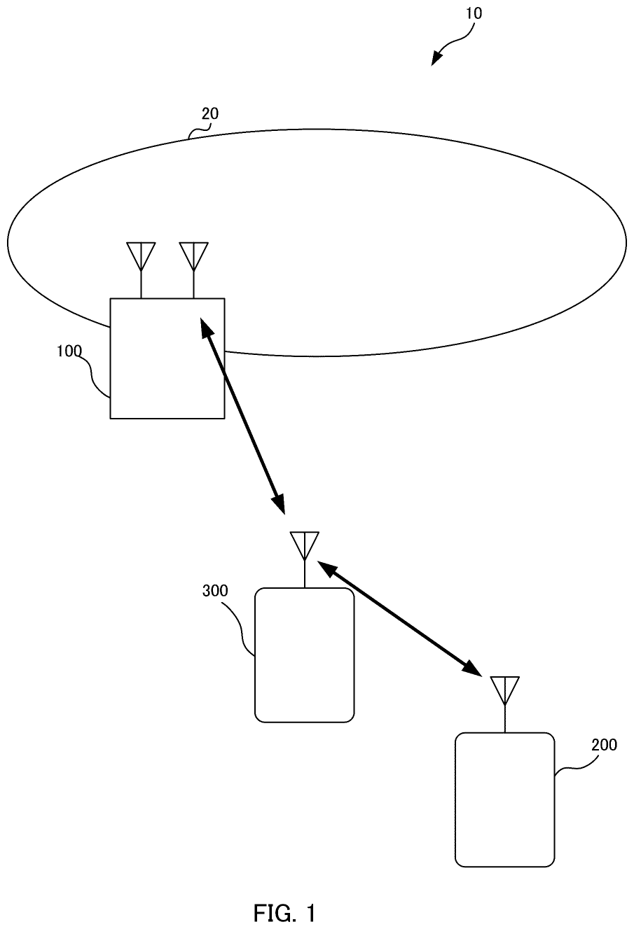

FIG. 1 is a diagram illustrating exemplary radio communication system 10 according to an embodiment of the present disclosure. Radio communication system 10 is a radio communication system in accordance with 5G NR, and includes Next Generation-Radio Access Network 20 (hereinafter, referred to as NG-RAN 20) and terminal 200 (hereinafter, also referred to as user equipment (UE) 200).

Note that radio communication system 10 may be a radio communication system in accordance with a method called Beyond 5G, 5G Evolution, or 6G.

NG-RAN 20 includes base station 100 (hereinafter also referred to as gNB 100). Note that the number of gNBs and UEs is not limited to the example shown in FIG. 1.

NG-RAN 20 actually includes a plurality of NG-RAN nodes, specifically, gNBs (or ng-eNBs), and is connected to a core network (5GC, not illustrated) in accordance with 5G. Note that NG-RAN 20 and 5GC may be simply referred to as “network.” Further, in the following, gNB may be read as a network (NW).

For example, gNB 100 is a base station in accordance with 5G, and performs radio communication with UE 200 in accordance with 5G. Further, in the example illustrated in FIG. 1, relay apparatus 300 that relays signals between gNB 100 and UE 200 is illustrated. Relay apparatus 300 performs a relay operation of, for example, transmitting a signal received from gNB 100 to UE 200 and transmitting a signal received from UE 200 to gNB 100. Note that the term “relaying” may be replaced with the term “forwarding.” Further, the term “operation” may be replaced with the term “processing,” “control,” or the like. Further, relay apparatus 300 which is being studied in NR will be described later.

gNB 100 and UE 200 may support MIMO (Multiple-Input Multiple-Output) that generates a beam with higher directivity by controlling a radio signal transmitted from a plurality of antenna elements, carrier aggregation (CA) that uses a plurality of component carriers (CCs) in a bundled manner, and dual connectivity (DC) that performs communication between UE and each of two NG-RAN nodes.

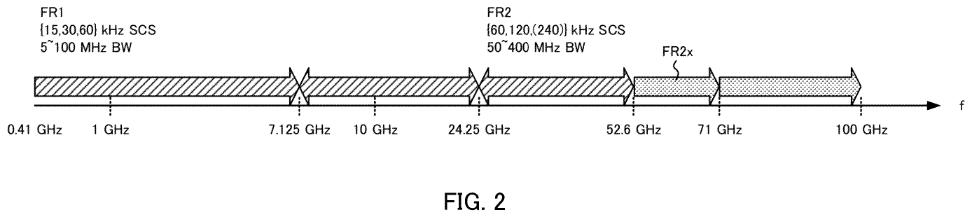

Further, radio communication system 10 may support a plurality of frequency ranges (FRs). FIG. 2 is a diagram illustrating examples of FRs used in radio communication system 10. As illustrated in FIG. 2, radio communication system 10 may support FR1 and FR2. The frequency band of each FR is, for example, as follows.
FR1: 410 MHz to 7.125 GHz
FR2: 24.25 GHz to 52.6 GHz

In FR1, a sub-carrier spacing (SCS) of 15 kHz, 30 kHz, or 60 kHz may be used, and a bandwidth (BW) of 5 to 100 MHz may be used. FR2 is a higher frequency than FR 1, and an SCS of 60 kHz or 120 kHz (240 kHz may be included) is used, and a bandwidth (BW) of 50 to 400 MHz may be used.

Note that SCS may be interpreted as numerology. Numerology is defined in 3GPP TS 38.300 and corresponds to one subcarrier spacing in the frequency domain.

Further, radio communication system 10 may support a frequency band higher than the frequency band of FR2. Specifically, radio communication system 10 may support a frequency band exceeding 52.6 GHz and up to 114.25 GHz. Such a high frequency band may be referred to as “FR2x” for convenience. In a case where a band exceeding 52.6 GHz is used, Cyclic Prefix-Orthogonal Frequency Division Multiplexing (CP-OFDM)/Discrete Fourier Transform-Spread-Orthogonal Frequency Division Multiplexing (DFT-S-OFDM) with a larger SCS may be applied.

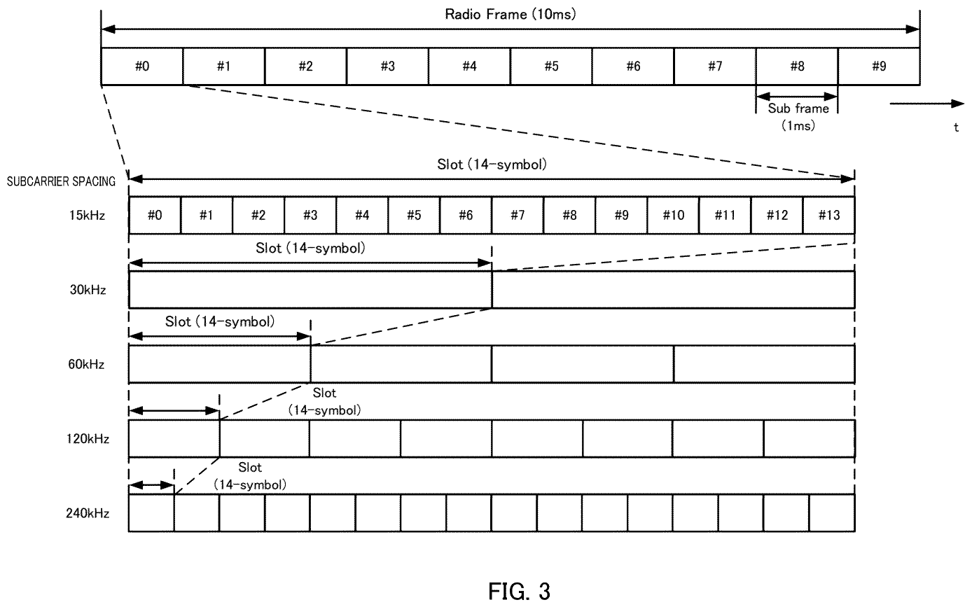

FIG. 3 is a diagram illustrating an exemplary configuration of a radio frame (system frame), a subframe, and a slot used in radio communication system 10. As illustrated in FIG. 3, one slot is configured with 14 symbols, and the symbol duration (and the slot duration) becomes shorter as the SCS becomes larger (wider). Note that the SCS is not limited to the durations (frequencies) illustrated in FIG. 3. For example, 480 kHz, 960 kHz, or the like may be used as the SCS.

Further, the number of symbols constituting one slot is not necessarily 14 symbols (for example, the number of symbols may be 28 or 56 symbols). Further, the number of slots per subframe may vary depending on the SCS.

Note that the time direction (t) illustrated in FIG. 3 may be referred to as a time domain, a symbol period, a symbol time, or the like. Further, the frequency direction may be referred to as a frequency domain, a resource block, a subcarrier, a bandwidth part (BWP), or the like.

gNB 100 transmits control information, configuration information, and the like of gNB 100 to UE 200 as a downlink (DL) signal.

Further, for example, gNB 100 receives, as an uplink (UL) signal, control information of gNB 100, a data signal, information on the processing capability of UE 200 (terminal capability (information); for example, UE capability), and the like from UE 200.

Relay apparatus 300 performs a transfer operation of transferring the DL signal to UE 200. Further, relay apparatus 300 performs a transfer operation of transferring the UL signal to gNB 100. Note that, in the following, the UL signal received by gNB 100 from UE 200 and/or the DL signal received by UE 200 from gNB 100 may be a signal relayed by relay apparatus 300.

UE 200 is a communication apparatus with a radio communication function, such as a smartphone, a mobile phone, a tablet, a wearable terminal, or a communication module for Machine-to-Machine (M2M).

UE 200 receives a control signal or a data signal from gNB 100 in DL and transmits a control signal or a data signal to gNB 100 in UL, thereby utilizing various communication services provided by radio communication system 10. Further, UE 200 receives various reference signals transmitted from gNB 100 and performs measurement of the propagation path quality based on the reception result of the reference signals.

The channel used for DL signal transmission includes, for example, a data channel and a control channel. For example, the data channel may include a Physical Downlink Shared Channel (PDSCH), and the control channel may include a Physical Downlink Control Channel (PDCCH). For example, gNB 100 transmits control information to UE 200 using PDCCH and transmits a DL data signal using PDSCH. Note that PDSCH is an example of a downlink shared channel, and PDCCH is an example of a downlink control channel. Note that the PDCCH may be read as downlink control information (DCI), control information, or the like transmitted in the PDCCH.

The reference signal included in the DL signal may include, for example, at least one of a demodulation reference signal (DMRS), a phase tracking reference signal (PTRS), a channel state information-reference signal (CSI-RS), a sounding reference signal (SRS), and a positioning reference signal (PRS). For example, reference signals such as DMRS and PTRS are used for demodulation of a data signal in DL and are transmitted using PDSCH.

The channel used for UL signal transmission includes, for example, a data channel and a control channel. For example, the data channel may include a Physical Uplink Shared Channel (PUSCH), and the control channel may include a Physical Uplink Control Channel (PUCCH). For example, UE 200 transmits control information using PUCCH and transmits a UL data signal using PUSCH. Note that PUSCH is an example of an uplink shared channel, and PUCCH is an example of an uplink control channel. The shared channel may also be referred to as a data channel. Note that PUSCH or PUCCH may be read as uplink control information (UCI), control information, or the like transmitted in PUSCH or PUCCH.

The reference signal included in the UL signal may include, for example, at least one of DMRS, PTRS, CSI-RS, SRSRS, and PRS for position information. For example, reference signals such as DMRS and PTRS are used for demodulation of UL data signals and are transmitted using PUSCH.

### Relay Apparatus

In Release 18 (Rel-18) of 3GPP, a new study item on NR Network-controlled Repeater is being considered. Hereinafter, a NR Network-controlled Repeater is abbreviated as NCR. NCR may correspond to, for example, relay apparatus 300 of FIG. 1. Hereinafter, NCR is sometimes referred to as NCR 300.

In NCR, unlike a conventional amplify and forward repeater, at least one of the control of the timing of transmission, the control of the timing of reception, the control of whether to perform a DL operation or a UL operation (for example, switching), and the control of turning ON and OFF the operation of NCR may be executed. Further, in NCR, it is possible to control the directivity in the transmission operation and/or the reception operation. That is, in NCR, the beam to be transmitted and/or the beam to be received may be controlled.

Hereinafter, control of turning ON and OFF the operation of NCR will be described by way of example.

For example, the following scenarios and/or assumptions have been considered with respect to NCR.

NCR may be an inband radio frequency (RF) repeater used to extend the network coverage of the FR1 and FR2 bands. Note that, in the study on FR2, the use of FR2 in both outdoor and outdoor to indoor (O2I) scenarios may be prioritized.

At present, a single-hop fixed NCR is being considered.

NCR may be transparent to the UE.

NCR may maintain and control the link between the gNB and the repeater and the link between the repeater and the UE simultaneously.

The efficiency of the cost of NCR is a consideration for NCR.

Further, the following examples are given as side control information.
Information on beamforming
Information on the timing for aligning the boundary between transmission and reception of NCR
Information on TDD configuration for UL and/or DL
Information on control of ON and OFF of NCR for efficient interference management and energy efficiency improvement (hereinafter referred to as ON-OFF control information)
Information on power control for efficient interference management Note that, among the examples of the side control information described above, the information necessary for NCR is under consideration. Further, in this study, it may be assumed that the NCR operates at the maximum transmission power.

Further, a method of L1/L2 (layer 1/layer 2) signaling for transmitting the side control information and a configuration of the L1/L2 signaling are under consideration.

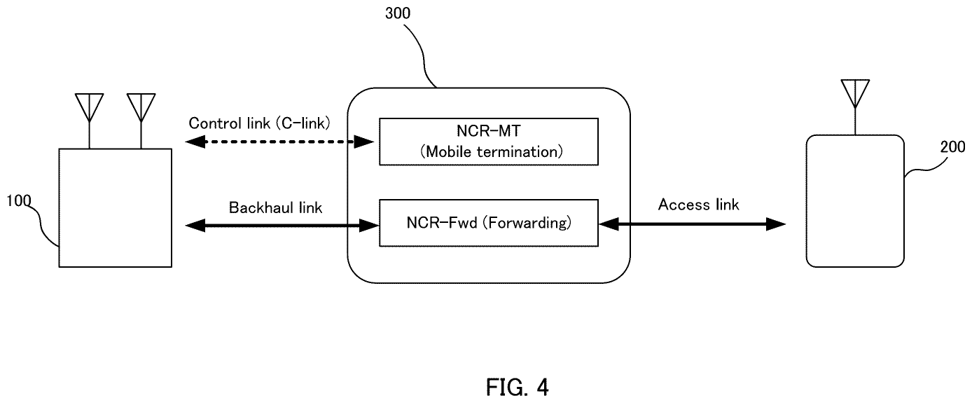

FIG. 4 is a diagram illustrating an exemplary configuration of NCR 300. NCR 300 is present between UE 200 and gNB 100. Note that, NCR 300 may be present between UE 200 and gNB 100 in the real space, or need not be present between UE 200 and gNB 100 in the real space.

NCR 300 receives a UL signal transmitted from UE 200 to gNB 100 and transmits the UL signal to the destination gNB 100. In other words, NCR 300 transfers the UL signal transmitted from UE 200 to gNB 100 to the destination gNB 100. Further, NCR 300 receives a DL signal transmitted from gNB 100 to UE 200 and transmits the DL signal to the destination UE 200. In other words, NCR 300 transfers a signal transmitted from gNB 100 to UE 200 to the destination UE 200.

Further, NCR 300 may operate based on control information received from gNB 100.

As illustrated in FIG. 4, the link between NCR 300 and UE 200 may be referred to as an access link. Further, as illustrated in FIG. 4, two links exist between NCR 300 and gNB 100. Of the two links, the link that transmits a signal received from UE 200 to gNB 100 may be referred to as a backhaul link. Note that, in the backhaul link, NCR 300 may receive a signal for UE 200 from gNB 100. Of the two links, the link for exchanging information between gNB 100 and NCR 300 may be referred to as a control link (hereinafter, sometimes referred to as a C-link). For example, in the control link, exchange of side control information may be performed.

Note that, in FIG. 4, an example is illustrated in which gNB 100 included in the C-link and gNB 100 included in the backhaul link are the same, but gNB 100 included in the C-link and gNB 100 included in the backhaul link may be different from each other.

Further, the frequency (for example, carrier or frequency band) used for communication in the C-link, the frequency used for communication in the backhaul link, and the frequency band used for communication in the access link are not particularly limited. These three frequencies may be the same as each other, or at least two of the three frequencies may be different from each other. Further, one of the three frequencies may include another one of the frequencies.

Further, for each of the three links, C-link, backhaul link, and access link, the link in the direction toward gNB 100 may be referred to as an uplink, and the link in the direction opposite to the uplink may be referred to as a downlink. In this case, the frequency used for uplink communication and the frequency used for downlink communication in each of the three links may be the same as each other or may be different from each other.

NCR 300 in FIG. 4 includes two functional entities referred to as NCR-MT and NCR-Fwd.

NCR-MT is a functional entity that communicates with gNB 100 via a control link (C-link) and enables information exchange with gNB 100. The information exchange with gNB 100 may be, for example, transmission and reception of side control information. Further, the control link may be based on the Uu interface of NR.

Note that, in NCR-MT, the side control information may include at least information for controlling NCR-Fwd. Further, the side control information may be indicated by at least one signaling of radio resource control (RRC), Medium Access Control Control Element (MAC CE), and downlink control information (DCI).

NCR-Fwd is a functional entity that transfers signals between gNB and UE via a backhaul link and an access link. For example, NCR-Fwd performs amplification and transfer of a UL radio frequency (RF) signal. Further, the amplification and transfer of the RF signal in the DL are performed. Note that the operation of NCR-Fwd may be controlled in accordance with the side control information received from gNB 100.

For the NCR illustrated in FIG. 4, it was agreed in 3 GPP RAN1 #109 that ON-OFF control of NCR would be supported.

For example, it has been agreed that the ON-OFF control information is valid for controlling the operation (or behavior) of NCR-Fwd in the ON-OFF control. However, the mechanism for indicating and determining ON-OFF control is under consideration. Further, an explicit indication or an implicit indication of the ON-OFF control information is under consideration.

Further, in RAN1 #109, the following points were agreed upon regarding transmission and reception in the C-link of NCR and transmission and reception in the backhaul link of NCR.

It was agreed that the UL of the C-link and the UL of the backhaul link are executed by time division multiplexing (TDM). On the other hand, simultaneous transmission of the UL of the C-link and the UL of the backhaul link depends on the function or capability of NCR. That is, NCR may have the capability to perform simultaneous transmission of the UL of the C-link and the UL of the backhaul link.

Further, the DL of the C-link and the DL of the backhaul link may be performed simultaneously or may be performed by TDM.

Note that, multiplexing using a TDM scheme or the like is controlled by gNB in consideration of the capability of NCR. For example, the TDM between the UL of the C-link and the UL of the backhaul link is controlled by gNB in consideration of the capability of NCR.

Note that, since the UL transmission in the C-link executed by NCR is executed by NCR-MT, which is a functional entity, the UL transmission is sometimes referred to as “NCR-MT C-link UL Tx.” Further, since the UL transmission in the backhaul link executed by NCR is executed by NCR-Fwd, which is a functional entity, the UL transmission is sometimes referred to as “NCR-Fwd backhaul link UL Tx.” Note that the UL transmission in the backhaul link executed by NCR may be coordinated with the UL reception in the access link. In a case where the UL transmission is coordinated with the UL reception in the access link, “NCR-Fwd backhaul link UL Tx” may include UL transmission in the backhaul link and UL reception in the access link.

Further, similarly for DL, the DL reception in the C-link executed by NCR is sometimes referred to as “NCR-MT C-link DL Rx,” and the DL reception in the backhaul link executed by NCR is sometimes referred to as “NCR-Fwd backhaul link DL Rx.” Note that the DL reception in the backhaul link executed by NCR may be coordinated with the DL transmission in the access link. In a case where the DL reception is coordinated with the DL transmission in the access link, “NCR-Fwd backhaul link DL Rx” may include DL reception in the backhaul link and DL transmission in the access link in NCR.

Further, regarding the ON-OFF control, indicating ON to NCR may correspond to transmitting an indication to turn NCR ON. Further, turning NCR ON may correspond to NCR turning NCR-Fwd ON based on an indication and NCR being turned ON based on an indication. Note that this indication may be explicit or implicit as described above. Further, turning NCR ON may correspond to changing the state of NCR from an OFF state to an ON state. Note that, based on the indication to turn NCR ON, of the two functional entities, NCR may turn NCR-Fwd ON and need not turn NCR-MT ON. For example, NCR-MT may continue to operate without being turned OFF, regardless of the indication to turn ON or OFF. In other words, turning NCR ON may be replaced with turning NCR-Fwd ON.

Further, regarding ON-OFF control, indicating OFF to NCR may correspond to transmitting an indication to turn NCR OFF. Further, turning NCR OFF may correspond to NCR turning NCR-Fwd OFF based on an indication and NCR being turned OFF based on an indication. Note that this indication may be explicit or implicit as described above. Further, turning NCR OFF may correspond to changing the state of NCR (or NCR-Fwd) from an ON state to an OFF state. Note that, based on the indication to turn NCR OFF, of the two functional entities, NCR may turn NCR-Fwd OFF and need not turn NCR-MT OFF. In other words, turning NCR OFF may be replaced with turning NCR-Fwd OFF.

Further, turning NCR ON may correspond to configuring a state in which the transfer operation in NCR is executable. Turning NCR ON may be read as activating NCR, configuring NCR to be available, enabling NCR, or the like. Further, NCR being ON in a certain time interval may mean transferring a signal from gNB to UE and/or transferring a signal from UE to gNB in the certain time interval. Here, the specific time interval may be, for example, a time interval having a unit such as a slot, a symbol, a subframe, a second, a millisecond (ms), or a microsecond (μs).

Further, turning NCR OFF may correspond to configuring a state in which the transfer operation in NCR is not executable. Turning NCR OFF may be read as putting NCR into a sleep state (or inactive), configuring NCR to be unavailable, disabling NCR, or the like. Further, NCR being OFF in a certain time interval may mean that no signal is transferred from gNB to UE and/or no signal is transferred from UE to gNB in the certain time interval.

### Consideration

In relation to the agreement on NCR, there is room for various considerations in the ON-OFF control of NCR.

For example, there is room for consideration regarding a gap (for example, a time width) between the time when NCR receives an indication to turn ON or OFF and the time when NCR actually reaches the state (for example, an ON state or an OFF state) based on the indication. For example, in a case where this gap is not considered, there is a possibility that a recognition discrepancy in the ON or OFF state occurs between the side that has transmitted the indication (for example, NW) and the NCR that has received the indication. Due to this discrepancy, there is a possibility that, for example, the transfer operation between the NCR and the gNB cannot be appropriately controlled because it is assumed that the NCR is in the ON state even though it is not in the ON state.

However, at present, only a state (for example, an ON state or an OFF state) based on the indication is defined, and a specific control is not defined for a gap (for example, a time width) between a time when NCR receives the indication and a time when NCR actually reaches the state based on the indication. Note that the specific control will be described in Proposal 1 described later.

Further, for example, there is room for consideration of a gap (for example, a transient period) for switching in a case where NCR is switched from ON to OFF or from OFF to ON. For example, in a case where this gap is not considered, there is a possibility that a recognition discrepancy in the ON or OFF state occurs between the side that has transmitted the switching indication (for example, NW) and the NCR that has received the indication. Due to this discrepancy, there is a possibility that, for example, the transfer operation between the NCR and the gNB cannot be appropriately controlled because it is assumed that the NCR is in the ON state even though it is not in the ON state.

However, at present, only the switching from ON to OFF or from OFF to ON is defined, and no specific control for the gap for switching is defined. Note that the specific control will be described in Proposal 2 and Proposal 3 described later.

Further, for example, there is room for consideration of a method in which the NCR indicates a resource which includes a gap as described above and in which the NCR is turned ON or OFF. For example, NCR may receive an indication of a resource that indicates a period to be ON (which may be referred to as an “ON period”) and a period to be OFF (which may be referred to as an “OFF period”), and it may be implicitly indicated that the period between the ON period and the OFF period configured based on the indication is a gap. In this case, since the period that is a gap (which may be referred to as a “gap period”) is not explicitly indicated, there is a possibility that the transfer operation between NCR and gNB cannot be appropriately controlled due to NCR misrecognizing the gap period. Accordingly, it is conceivable to indicate a resource that indicates a gap period in addition to the ON period and the OFF period. Note that this specific control (for example, indication) will be described in Proposal 4 described later.

Further, for example, there is room for consideration of the control of the number of times of switching in a case where NCR is switched from ON to OFF or from OFF to ON. For example, in a case where the number of times of switching is not appropriately controlled, the number of times of switching unnecessarily increases, which increases the number of gaps as described above, thereby wasting time resources. Further, the power consumption of the NCR may also increase as the number of times of switching increases. Note that the control of the number of times of switching will be described in Proposal 5 described later.

With respect to the above-described considerations, in the present embodiment, in a case where a state (ON state or OFF state) related to a transfer operation executed by NCR is changed to a certain specific state (for example, one of the ON state or the OFF state), NCR provides a certain period before the period of the certain specific state to change the state to the certain specific state. The specific period corresponds to, for example, the gap described above. Providing a specific period allows the transfer operation to be appropriately controlled. Note that the term “period” may be replaced with other terms such as time interval, interval, gap, and the like.

Hereinafter, each proposal will be described.

### Proposal 1

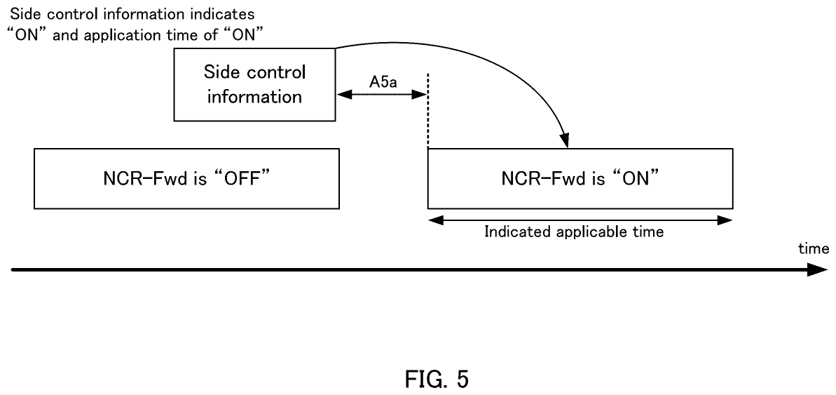

FIG. 5 is a diagram illustrating an example of a relationship between the side control information and the application time of ON. FIG. 5 illustrates a time when NCR-Fwd is OFF (NCR-Fwd is “OFF” in FIG. 5), a time when NCR-Fwd is ON (NCR-Fwd is “ON” in FIG. 5), and a time (timing) when side control information indicating ON of NCR and indicating the application time of ON of NCR is received. The side control information may be received, for example, via a C-link.

Here, considering that NCR requires a specific time to switch between ON and OFF of NCR-Fwd, a gap between the time when NCR receives the side control information and the time when the ON and/or OFF (abbreviated as ON/OFF) of NCR-Fwd is applied needs to be considered. For example, the gap indicated by arrow A5a in FIG. 5 needs to be considered.

In a case where this gap is not considered, a recognition discrepancy regarding the ON or OFF state possibly occurs between the side that has transmitted the switching indication (for example, NW) and the NCR that has received the indication. Due to this discrepancy, there is a possibility that, for example, the transfer operation between the NCR and the gNB cannot be appropriately controlled because it is assumed that the NCR is in the ON state even though it is not in the ON state.

Accordingly, in Proposal 1, the timing for turning ON/OFF is defined when NCR receives an indication for the operation (for example, an ON/OFF indication). For example, the timing at which the NCR performs an operation based on the indication is defined when the NCR receives the indication for the operation. Exemplarily, in Proposal 1, the gap from when the NCR receives the indication for the operation to when the NCR performs the operation based on the indication is defined.

With this configuration, gNB and NCR can reduce the discrepancy in the ON/OFF state between gNB and NCR, and can appropriately control the transfer operation between NCR and gNB.

For example, gNB indicates the timing for turning NCR-Fwd ON/OFF to NCR using the side control information, so that NCR can grasp the timing for turning NCR-Fwd ON/OFF. Further, since the operation of NCR for the indication of the timing is defined, gNB can grasp the timing at which NCR turns NCR-Fwd ON/OFF, for example, and thus, the transfer operation can be appropriately performed.

Here, in Proposal 1, it is assumed that the side control information indicates ON and/or OFF (abbreviated as ON/OFF) of NCR (for example, NCR-Fwd) and clearly indicates the application time of ON/OFF. Note that, the side control information indicating the ON/OFF of NCR corresponds to the side control information including information indicating an instruction related to the ON/OFF of NCR. Further, the side control information clearly indicating the application time of ON/OFF corresponds to the side control information including information indicating the application time of ON/OFF. The information indicating an instruction on the application time of ON/OFF may be, for example, at least one of information indicating the start timing of the application time of ON/OFF, information indicating the end timing of the application time of ON/OFF, and information indicating the length of the application time of ON/OFF. The side control information may be included in, for example, at least one of DCI, MAC CE, and RRC.

### Proposal 1-1

In Proposal 1-1, the gap between the time when the NCR receives the side control information and the time when ON of NCR-Fwd is applied is considered.

Here, in Proposal 1-1, it is assumed that the side control information indicates ON of NCR-Fwd and clearly indicates the application time of ON.

Then, the operation in a case where NCR receives the side control information including the indication of ON of NCR-Fwd and the indication of the application time of ON is defined.

Here, a gap between the time when the side control information is received and the start time of the application time indicated by the side control information is assumed to be X1. The time unit of X1 may be one of a slot, a symbol, a subframe, a second, a millisecond (ms), and a microsecond (μs).

Note that, in the following description, the “time at which the side control information is received” may refer to a specific time (or a specific timing) within the time interval in which the side control information is received. For example, the time at which the side control information is received may be the first symbol, the last symbol, or a specific symbol other than the first and last symbols among the symbols in which the side control information is received. Note that the side control information may be received in one symbol. Further, for example, the time at which the side control information is received may be the first slot, the last slot, or a specific slot other than the first and last slots among the slots in which the side control information is received. Note that the side control information may be received in one slot. In this case, the time at which the side control information is received may be the slot in which the side control information is received. The way of indicating the time at which the side control information is received is not limited to the example described above.

Further, here, the time required for NCR to switch NCR-Fwd from OFF to ON is assumed to be Y1. The time unit of Y1 may be one of a slot, a symbol, a subframe, a second, a millisecond (ms), and a microsecond (μs).

Y1 may be a predefined value, a value configured by control information or the like, or a value that is the subject of the Capability of NCR. In other words, this assumption corresponds to the fact that NCR cannot switch NCR-Fwd from OFF to ON in a time shorter than Y1. Note that the term “predefined” may refer to being defined by a specification or may refer to being defined by an implementation (for example, a configuration of NCR). Further, the term “configured” may refer to being configured by a parameter explicitly indicated by received control information or the like, or may refer to being configured by a parameter implicitly indicated. Here, the control information may be side control information or may be another control information obtained by RRC, MAC CE, or DCI. Further, being the subject of the capability may refer to being a subject indicated by NCR to NW (for example, gNB) as a capability.

Regarding the relationship between X1 and Y1 in a case where NCR receives side control information including an indication of ON of NCR-Fwd and an indication of the application time of ON, three options will be described below with reference to the drawings. Note that any of the following three options may be applied.

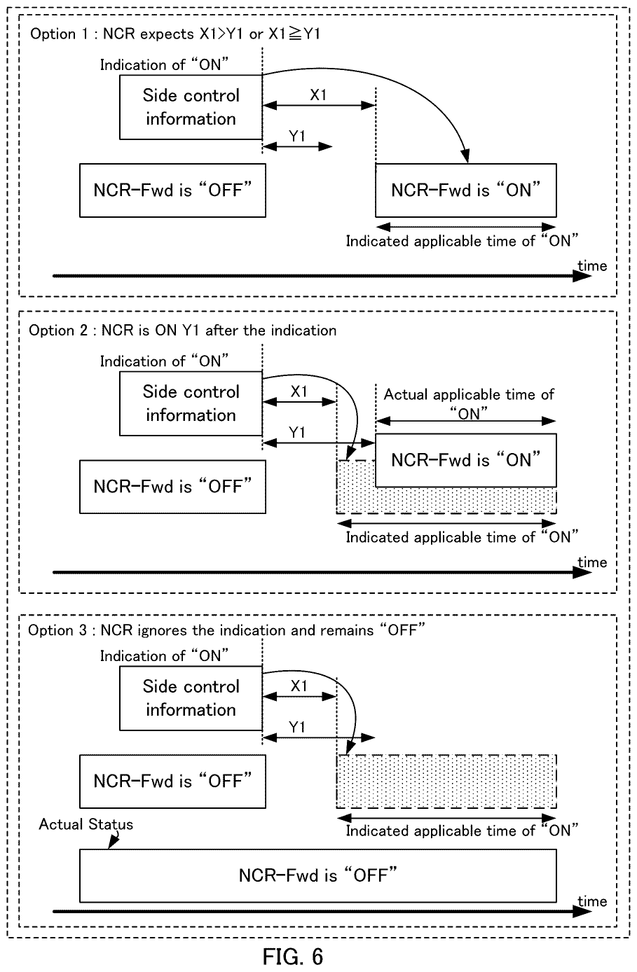

FIG. 6 is a diagram illustrating an example of Proposal 1-1. FIG. 6 illustrates respective examples of Options 1 to 3 of Proposal 1-1. In each example, the following times are indicated: the time when NCR-Fwd is OFF (“NCR-Fwd is ”OFF“); the time when NCR-Fwd is ON (”NCR-Fwd is “ON”); and the time (timing) when side control information indicating the time when NCR is ON and the application time of ON of NCR is received. Further, each example illustrates X1, which represents the gap between the time when the side control information is received and the start time of the application time of ON indicated by the side control information, and Y1, which represents the time required for NCR to switch NCR-Fwd from OFF to ON.

### Option 1 of Proposal 1-1

In Option 1 of Proposal 1-1, NCR may assume that the magnitude relationship between X1 and Y1 is limited. For example, NCR assumes that X1 is greater than Y1 (that is, X1>Y1) or that X1 is equal to or greater than Y1 (that is, X1≥Y1). In other words, in Option 1 of Proposal 1-1, NCR does not need to assume that X1 is less than Y1 (X1<Y1) or that X1 is equal to or less than Y1 (that is, X1≤Y1).

Further, in Option 1 of Proposal 1-1, the NW that transmits the indication to the NCR indicates X1 that is greater than Y1 or X1 that is equal to or greater than Y1. Further, in Option 1 of Proposal 1-1, the NW that transmits the indication to the NCR does not indicate X1 less than Y1 or X1 equal to or less than Y1. Note that X1 may be indicated explicitly by the NW or may be indicated implicitly by the NW.

As illustrated in the example of Option 1 in FIG. 6, X1, which indicates the gap between the time at which the side control information is received and the start time of the application time of ON indicated by the side control information, is greater than Y1. In this case, NCR turns NCR-Fwd ON during the application time of ON (referred to as “Indicated applicable time of ON” in the figure) based on the indication.

In Option 1 of Proposal 1-1, by assuming that X1 is greater than Y1 or that X1 is equal to or greater than Y1, X1 that is less than Y1 or X1 that is equal to or less than Y1 is not indicated to NCR. Therefore, it is possible to secure the time required for NCR to switch NCR-Fwd from OFF to ON, and to turn NCR-Fwd ON at the indicated timing, thereby controlling the appropriate transfer operation.

### Option 2 of Proposal 1-1

In Option 2 of Proposal 1-1, there may be no limitation on the magnitude relationship between X1 and Y1. For example, NCR need not assume that there is a limitation on the magnitude relationship between X1 and Y1. In this case, X1 may be less than Y1, or X1 may be equal to or greater than Y1. Further, in Option 2 of Proposal 1-1, in a case where X1<Y1 (or in a case where X1≤Y1), it may be assumed that NCR turns NCR-Fwd ON after Y1 elapses after the side control information is received, and it need not be assumed that NCR turns NCR-Fwd ON before Y1 elapses after the side control information is received. Note that, the phrase “it need not be assumed that NCR turns NCR-Fwd ON before Y1 elapses after the side control information is received” may be interpreted as “it need not be required that NCR turn NCR-Fwd ON before Y1 elapses after the side control information is received.” Further, in Option 2 of Proposal 1-1, the NW that transmits the indication to the NCR may indicate X1 that is less than Y1 or X1 that is equal to or less than Y1. Note that X1 may be indicated explicitly from the NW or may be indicated implicitly from the NW. For example, an NW that transmits the indication common to a plurality of NCRs may indicate X1 that is less than Y1 of a specific NCR, to the plurality of NCRs including the specific NCR.

In the example of Option 2 in FIG. 6, X1, which indicates the gap between the time at which the side control information is received and the start time of the application time of ON indicated by the side control information, is less than Y1. In this case, as illustrated in the example of Option 2 in FIG. 6, NCR may turn NCR-Fwd ON after Y1 elapses after the reception of the side control information, and does not turn NCR-Fwd ON before Y1 elapses after the reception of the side control information. Further, in this case, NCR turns NCR-Fwd ON in an actual application time of ON (“Actual applicable time of ON” in the figure) that is shorter than the application time of ON based on the indication (“Indicated applicable time of ON” in the figure).

Note that, in the example of Option 2 in FIG. 6, Y1 is greater than X1, causing the start timing of the actual application time of ON to be shifted to a later time than the start timing of the application time of ON based on the indication. Further, in the example of Option 2 in FIG. 6, the end timing of the actual application time of ON matches the end timing of the application time of ON based on the indication. As described above, even in a case where the start timing of the application time of ON is shifted, the end timing of the actual application time of ON matches the end timing of the application time of ON based on the indication, thereby enabling the application period of ON to be ended based on the indication.

Note that, in the example of Option 2 in FIG. 6, the end timing of the actual application time of ON matches the end timing of the application time of ON based on the indication, but the present disclosure is not limited thereto. For example, the end timing of the application time of ON may be shifted depending on the shift of the start timing of the application time of ON. By shifting the end timing of the application time of ON depending on the shift of the start timing of the application time of ON, the length of the application time of ON can be the same as the length based on the indication.

In Option 2 of Proposal 1-1, even in a case where X1 less than Y1 or X1 equal to or less than Y1 is indicated to NCR, NCR-Fwd is turned ON after Y1 elapses. Therefore, it is possible to secure the time required for NCR to switch NCR-Fwd from OFF to ON, and to control an appropriate relay operation (transfer operation).

### Option 3 of Proposal 1-1

In Option 3 of Proposal 1-1, no limitation may be applied to the magnitude relationship between X1 and Y1, similarly to Option 2 of Proposal 1-1. Further, in Option 3 of Proposal 1-1, in a case where X1<Y1 (or in a case where X1≤Y1), NCR may ignore the side control information including an indication to turn NCR-Fwd ON and may maintain the OFF state of NCR-Fwd. Note that, in a case where the side control information includes information different from an indication to turn NCR-Fwd ON, NCR need not ignore the information different from the indication to turn NCR-Fwd ON.

Further, in Option 3 of Proposal 1-1, the NW that performs indication to the NCR may indicate X1 less than Y1 or X1 equal to or less than Y1, similarly to Option 2. Note that X1 may be indicated explicitly from the NW or may be indicated implicitly from the NW. For example, an NW that performs indication common to a plurality of NCRs may indicate X1 that is less than Y1 of a specific NCR, to the plurality of NCRs including the specific NCR.

In the example of Option 3 in FIG. 6, X1, which indicates the gap between the time at which the side control information is received and the start time of the application time of ON indicated by the side control information, is less than Y1. In this case, as illustrated in the example of Option 3 in FIG. 6, NCR ignores the side control information including the indication to turn NCR-Fwd ON, and maintains the OFF state of NCR-Fwd without turning NCR-Fwd ON in the indicated application time of ON (“Indicated applicable time of ”ON“” in the figure).

In Option 3 of Proposal 1-1, in a case where X1 less than Y1 or X1 equal to or less than Y1 is indicated to NCR, the OFF state of NCR-Fwd is maintained without NCR-Fwd being turned ON. Thus, the operation of not switching to ON can be selected in a case where the time required for NCR to switch NCR-Fwd from OFF to ON cannot be ensured, and thus, an appropriate relay operation (transfer operation) can be controlled.

Note that, in Proposal 1 -1 described above, X1 need not be indicated. In this case, NCR may turn NCR-Fwd ON after Y1 elapses after the side control information is received. Note that, in this case, the side control information need not include an indication (for example, X1) regarding the application time of ON of NCR-Fwd.

### Proposal 1-2

In Proposal 1-2, the gap between the time when the NCR receives the side control information and the application time of OFF of NCR-Fwd is considered.

Here, in Proposal 1-2, it is assumed that the side control information indicates OFF of NCR-Fwd and clearly indicates the application time of the OFF.

Further, the operation in a case where NCR receives side control information including an indication of OFF of NCR-Fwd and an indication of the application time of OFF is defined.

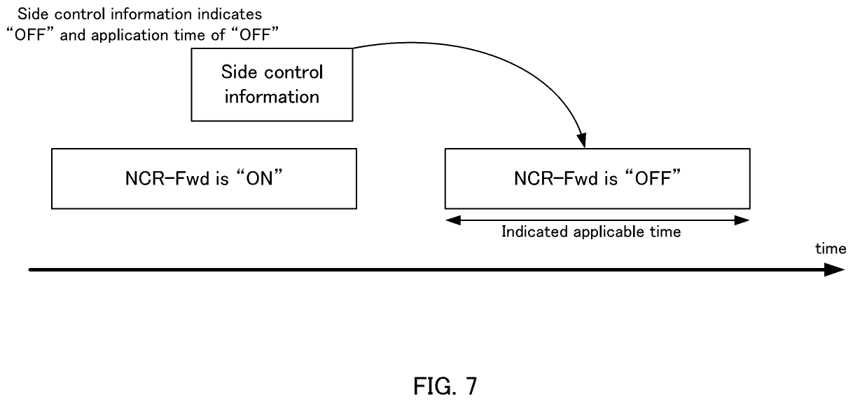

FIG. 7 is a diagram illustrating an example of the relationship between the side control information and the application time of OFF. FIG. 7 illustrates a time when NCR-Fwd is ON (“NCR-Fwd is ”ON“ in FIG. 7), a time when NCR-Fwd is OFF (”NCR-Fwd is “OFF” in FIG. 7), and a time (timing) when side control information indicating OFF of NCR and indicating the application time of OFF of NCR is received. The side control information may be received, for example, via a C-link.

Here, a gap between the time at which the side control information is received and the start time of the application time indicated by the side control information is assumed to be X2. The time unit of X2 may be one of a slot, a symbol, a subframe, a second, a millisecond (ms), and a microsecond (μs).

Note that, in the following description, the “time at which the side control information is received” may refer to a specific time (or a specific timing) within the time interval in which the side control information is received. For example, the time at which the side control information is received may be the first symbol, the last symbol, or a specific symbol other than the first and last symbols among the symbols in which the side control information is received. Note that the side control information may be received in one symbol. Further, for example, the time at which the side control information is received may be the first slot, the last slot, or a specific slot other than the first and last slots among the slots in which the side control information is received. Note that the side control information may be received in one slot. In this case, the time at which the side control information is received may be the slot in which the side control information is received. The way of indicating the time at which the side control information is received is not limited to the example described above.

Further, here, the time required for NCR to switch NCR-Fwd from ON to OFF is assumed to be Y2. The time unit of Y2 may be one of a slot, a symbol, a subframe, a second, a millisecond (ms), and a microsecond (μs).

Y2 may be a value defined in advance, a value set by control information, or a value that is the subject of the Capability of NCR. In other words, this assumption corresponds to the fact that NCR cannot switch NCR-Fwd from ON to OFF in a time shorter than Y2. Note that Y2 may be the same as Y1 described in Proposal 1 -1 or may be different from Y1.

Regarding the relationship between X2 and Y2 in a case where NCR receives side control information including an indication of OFF of NCR-Fwd and an indication of the application time of OFF, three options will be described below with reference to the drawings. Note that any of the following three options may be applied.

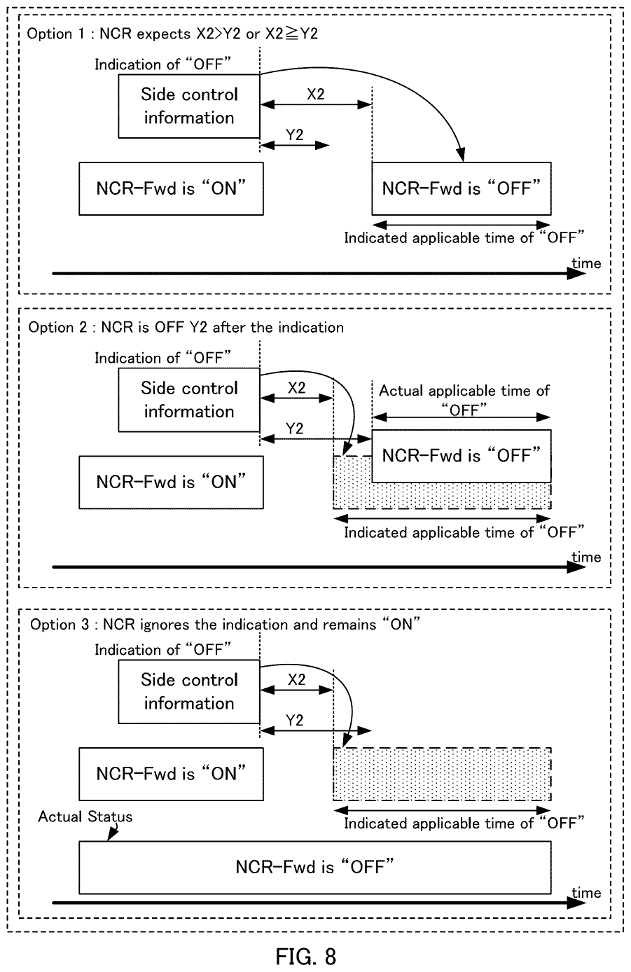

FIG. 8 is a diagram illustrating an example of Proposal 1-2. FIG. 8 illustrates respective examples of Options 1 to 3 of Proposal 1-2. In each example, the following times are indicated: the time when NCR-Fwd is ON (“NCR-Fwd is ”ON“); the time when NCR-Fwd is OFF (”NCR-Fwd is “OFF”); and the time (timing) when side control information indicating the time of NCR being OFF and the application time of OFF of NCR is received. Further, each example illustrates X2, which represents the gap between the time at which the side control information is received and the start time of the application time of OFF indicated by the side control information, and Y2, which represents the time required for NCR to switch NCR-Fwd from ON to OFF.

### Option 1 of Proposal 1-2

In Option 1 of Proposal 1-2, NCR may assume that the magnitude relationship between X2 and Y2 is limited. For example, NCR assumes that X2 is greater than Y2 (that is, X2>Y2) or that X2 is equal to or greater than Y2 (that is, X2≥Y2). In other words, in Option 1 of Proposal 1-2, NCR does not need to assume that X2 is less than Y2 (X2<Y2) or that X2 is equal to or less than Y2 (that is, X2≤Y2).

Further, in Option 1 of Proposal 1-2, the NW that transmits the indication to the NCR indicates X2 that is greater than Y2 or X2 that is equal to or greater than Y2. Further, in Option 1 of Proposal 1-2, the NW that transmits the indication to the NCR does not indicate X2 less than Y2 or X2 equal to or less than Y2. Note that X2 may be indicated explicitly from the NW or may be indicated implicitly from the NW.

As illustrated in the example of Option 1 in FIG. 8, X2, which indicates the gap between the time at which the side control information is received and the start time of the application time of OFF indicated by the side control information, is greater than Y2. In this case, NCR turns NCR-Fwd OFF during the indicated application time of OFF (referred to as “Indicated applicable time of OFF” in the figure) based on the indication.

In Option 1 of Proposal 1-2, by assuming that X2 is greater than Y2 or X2 is equal to or greater than Y2, X2 that is less than Y2 or X2 that is equal to or less than Y2 is not indicated to NCR. Therefore, it is possible to secure the time required for NCR to switch NCR-Fwd from ON to OFF, and to turn NCR-Fwd OFF at the indicated timing, thereby controlling an appropriate relay operation (transfer operation).

### Option 2 of Proposal 1-2

In Option 2 of Proposal 1-2, there may be no limitation on the magnitude relationship between X2 and Y2. For example, NCR need not assume that there is a limitation on the magnitude relationship between X2 and Y2. In this case, X2 may be less than Y2, or X2 may be equal to or greater than Y 2. In Option 2 of Proposal 1-2, in a case where X2<Y2 (or X2≤Y2), it may be assumed that NCR turns NCR-Fwd OFF after Y2 elapses after the reception of the side control information, and it need not be assumed that NCR turns NCR-Fwd OFF before Y2 elapses after the reception of the side control information. Note that, the phrase “it need not be assumed that NCR turns NCR-Fwd OFF before Y2 elapses after the reception of the side control information” may be interpreted as “it need not be required that NCR turn NCR-Fwd OFF before Y2 elapses after the reception of the side control information.”

Further, in Option 2 of Proposal 1-2, the NW that transmits the indication to the NCR may indicate X2 that is less than Y2 or X2 that is equal to or less than Y2. Note that X2 may be indicated explicitly from the NW or may be indicated implicitly from the NW. For example, an NW that transmits the indication common to a plurality of NCRs may indicate X2 that is less than Y2 of a specific NCR, to the plurality of NCRs including the specific NCR.

In the example of Option 2 in FIG. 8, X2, which indicates the gap between the time at which the side control information is received and the start time of the application time of OFF indicated by the side control information, is less than Y2. In this case, as illustrated in the example of Option 2 in FIG. 8, NCR may turn NCR-Fwd OFF after Y2 elapses from the reception of the side control information, and does not turn NCR-Fwd OFF before Y2 elapses after the reception of the side control information. Further, in this case, NCR turns NCR-Fwd OFF in an actual application time of OFF (in the figure, “Actual applicable time of OFF”) that is shorter than the indicated application time of OFF (in the figure, “Indicated applicable time of OFF”) based on the indication.

Note that, in the example of Option 2 in FIG. 8, Y2 is greater than X2, causing the start timing of the actual application time of OFF to be shifted to a timing later than the start timing of the application time of OFF based on the indication. Further, in the example of Option 2 in FIG. 8, the end timing of the actual application time of OFF matches the end timing of the application time of OFF based on the indication. As described above, even in a case where the start timing of the application time of OFF is shifted, the end timing of the actual application time of OFF matches the end timing of the application time of OFF based on the indication, thereby ending the application period of OFF to be ended based on the indication.

Note that, in the example of Option 2 in FIG. 8, the end timing of the actual application time of OFF matches the end timing of the application time of OFF based on the indication, but the present disclosure is not limited thereto. For example, the end timing of the application time of OFF may be shifted depending on the shift of the start timing of the application time of OFF. By shifting the end timing of the application time of OFF depending on the shift of the start timing of the application time of OFF, the length of the application time of OFF can be the same with the length based on the indication.

In Option 2 of Proposal 1-2, even in a case where X2 less than Y2 or X2 equal to or less than Y2 is indicated to NCR, NCR-Fwd is turned OFF after Y2 elapses. Therefore, it is possible to secure the time required for NCR to switch NCR-Fwd from ON to OFF, and to control an appropriate relay operation (transfer operation).

### Option 3 of Proposal 1-2

In Option 3 of Proposal 1-2, no limitation may be applied to the magnitude relationship between X2 and Y2, similarly to Option 2 of Proposal 1-2. Further, in Option 3 of Proposal 1-2, in a case where X2<Y2 (or in a case where X2≤Y2), NCR may ignore the side control information including an indication to turn NCR-Fwd OFF and may maintain the ON state of NCR-Fwd. Note that, here, in a case where the side control information includes information different from an indication to turn NCR-Fwd OFF, NCR need not ignore the information different from the indication to turn NCR-Fwd OFF.

Further, in Option 3 of Proposal 1-2, the NW that performs indication to the NCR may indicate X2 less than Y2 or X2 equal to or less than Y2, similarly to Option 2. Note that X2 may be indicated explicitly from the NW or may be indicated implicitly from the NW. For example, an NW that performs indication common to a plurality of NCRs may indicate X2 that is less than Y2 of a specific NCR, to the plurality of NCRs including the specific NCR.

In the example of Option 3 in FIG. 8, X2, which indicates the gap between the time at which the side control information is received and the start time of the application time of OFF indicated by the side control information, is less than Y2. In this case, as illustrated in the example of Option 3 in FIG. 8, NCR ignores the side control information including the indication to turn NCR-Fwd OFF, and maintains the ON state of NCR-Fwd without turning NCR-Fwd OFF in the indicated application time of OFF (“Indicated applicable time of “OFF”” in the figure).

In Option 3 of Proposal 1-2, in a case where X2 less than Y2 or X2 equal to or less than Y2 is indicated to NCR, the ON state of NCR-Fwd is maintained without NCR-Fwd being turned OFF. Thus, the operation of not switching to OFF can be selected in a case where the time required for NCR to switch NCR-Fwd from ON to OFF cannot be ensured, and thus, it is possible to control an appropriate relay operation (transfer operation).

Note that, in Proposal 1-2 described above, X2 need not be indicated. In this case, NCR may turn NCR-Fwd OFF after Y2 elapses after the side control information is received. Note that, in this case, the side control information need not include an indication (for example, X2) regarding the application time of OFF of NCR-Fwd.

As described above, in Proposal 1, when the NCR receives an indication related to an operation, the gap between the time when the NCR receives the indication and the time when the NCR performs the operation based on the indication is defined as an example of the timing for performing the operation based on the indication. Thus, it is possible to consider that NCR requires a specific time to switch NCR-Fwd between ON and OFF, and also possible to consider the gap between the time when the NCR receives the side control information and the application time of ON/OFF of NCR-Fwd, thereby enabling the appropriate control of the transfer operation.

For example, in a case where this gap is considered, the operation (transfer operation) of NCR-Fwd in consideration of the presence of the gap can be controlled between the NW that indicates ON/OFF of NCR-Fwd to NCR and the NCR that receives the indication.

For example, in a case where the gap is considered, it is possible to avoid a discrepancy between the start timing of the application time of ON of NCR-Fwd recognized by the NW that has indicated ON of NCR-Fwd to NCR and the start timing of the actual application time of ON of NCR-Fwd after the gap. Avoiding the timing discrepancy allows the NW to recognize the time during which NCR-Fwd cannot perform the transfer operation, for example, which allows for the appropriate transfer operation, avoids communication quality degradation, and avoids a decrease in throughput.

Further, for example, in a case where the gap is considered, it is possible to avoid a discrepancy between the start timing of the application time of OFF of NCR-Fwd recognized by the NW that has indicated OFF of NCR-Fwd to NCR and the start timing of the actual application time of OFF of NCR-Fwd after the gap. Avoiding the timing discrepancy allows the NW to recognize the time during which NCR-Fwd cannot perform the transfer operation, for example, which allows for the appropriate transfer operation, avoids communication quality degradation, and avoids a decrease in throughput.

For example, in Proposal 1, when NCR (an example of a communication apparatus) switches a state related to a transfer operation executed by the NCR between gNB (an example of a base station) and UE (an example of a terminal) to a certain first state (for example, one of an ON state or an OFF state), the NCR configures a gap (an example of a specific period) before the period of the first state, and switches the state to the first state. Then, the NCR transmits or receives a signal related to the transfer in accordance with the first state.

For example, in Proposal 1, when NCR receives the indication indicating the first state (for example, one of an ON state or an OFF state), the NCR configures a gap between the time when the indication is received and the time when the period (application time of ON) of the first state is started.

### Proposal 2

For a normal UE, the requirement for the transmission power of the UE is specified in 3GPP TS 38.101 (RAN4 spec. of requirement of UE). Further, in this specification, a mask for ON/OFF of transmission is defined. The mask for ON/OFF of transmission defines a transient period that is allowed between a symbol of power in which transmission is OFF (transmit OFF power) and a symbol of power in which transmission is ON.

Note that the measurement period of the OFF power may be defined within the width of at least one slot excluding any transient period. Further, the ON power may be defined as the average power within one slot excluding any transient period.

With respect to the ON-OFF control of NCR, the same cases as those of the normal UE described above should be considered. That is, with respect to the ON-OFF control of NCR, a transient period for ON-OFF switching should be considered.

Accordingly, in Proposal 2, a transient period in a case where the operation of NCR (for example, the operation of NCR-Fwd) is switched from ON to OFF (or from OFF to ON) is defined. Note that the term “transient period” may be replaced with another expression such as a transient state period, a transition period, a state transition period, or the like.

Note that, the transient period when switching from ON to OFF (or from OFF to ON) may be shorter than a CP (cyclic prefix) or may be shorter than a symbol. For example, in a case where the transient period is shorter than a CP or a symbol, Proposal 2 may be a proposal for a study item in RAN4 only rather than a study item in RAN1 of 3GPP. On the other hand, the transient period may be equal to or longer than a CP, or may be equal to or longer than a symbol. For example, in a case where the transient period is equal to or longer than a CP or equal to or longer than a symbol, Proposal 2 may be a proposal for a study item in RAN1 and/or a study item in RAN4 of 3GPP.

### Proposal 2-1

In Proposal 2-1, it is assumed that the ON period and the OFF period are continuous. The NCR may be indicated with a pattern related to the ON period and the OFF period (hereinafter, sometimes abbreviated as an ON-OFF pattern). Further, the ON-OFF pattern may indicate that the ON period and the OFF period are continuous. Note that the ON period and the OFF period may be respectively replaced with the application time of ON and the application time of OFF in the same manner as in the example described in Proposal 1.

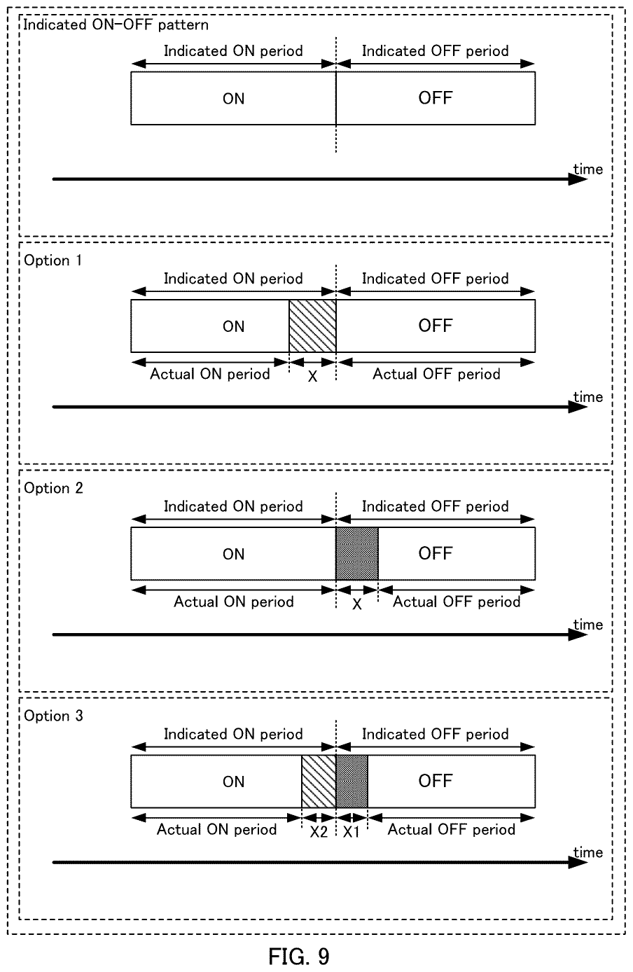

For the transient period in the switching from ON to OFF, three options will be described below with reference to FIG. 9. For the transient period in which the ON period and the OFF period are continuous, any of the three options may be adopted.

FIG. 9 is a diagram illustrating an example of a continuous ON period and OFF period. In the example of FIG. 9, the ON period and the OFF period in a case where the ON period transitions to the OFF period, that is, in a case where the ON period is switched to the OFF period, are illustrated. For example, FIG. 9 illustrates the indicated ON-OFF patterns and the cases where Options 1 to 3 are applied to the indicated ON-OFF pattern.

The indicated ON-OFF pattern (referred to as “Indicated ON-OFF pattern” in the figure) shows that the indicated ON period and the indicated OFF period are continuous. Three options applied to this pattern will be described below.

### Option 1 of Proposal 2-1

In Option 1 of Proposal 2-1, the transient period is defined within the indicated ON period. For example, as illustrated in the example of Option 1 in FIG. 9, the transient period is the last time interval of X in the indicated ON period. In Option 1 of Proposal 2-1, the actual ON period may be a time interval obtained by excluding the last time interval of X from the indicated ON period.

Note that, NCR-Fwd may be assumed to be turned ON in the actual ON period. Alternatively, NCR-Fwd may be required to be turned ON in the actual ON period. Note that the request to turn NCR-Fwd ON may be based on the actual ON period. In other words, NCR-Fwd need not be assumed to be turned ON or need not be required to be turned ON in the transient period.

Here, X, which is a time interval corresponding to the transient period, may be defined in advance, may be configured, or may be the subject of the Capability of NCR.

In Option 1 of Proposal 2-1, the transient period is defined within the indicated ON period. Thus, NCR and gNB can configure the ON period and the OFF period in consideration of the transient period, and thus, the appropriate transfer operation can be controlled. Further, defining the transient period within the indicated ON period shortens the length of the ON period, thereby reducing the power consumption of the NCR.

### Option 2 of Proposal 2-1

In Option 2 of Proposal 2-1, the transient period is defined within the indicated OFF period. For example, as illustrated in the example of Option 2 in FIG. 9, the transient period is the first time interval of X in the indicated OFF period. In Option 2 of Proposal 2-1, the actual OFF period may be a time interval obtained by excluding the first time interval of X from the indicated OFF period.

Note that, NCR-Fwd may be assumed to be turned OFF in the actual OFF period. Alternatively, NCR-Fwd may be required to be turned OFF in the actual OFF period. Note that the request to turn NCR-Fwd OFF may be based on the actual OFF period. In other words, NCR-Fwd need not be assumed to be turned OFF or need not be required to be turned OFF in the transient period.

Here, X, which is a time interval corresponding to the transient period, may be defined in advance, may be configured, or may be the subject of the Capability of NCR.

In Option 2 of Proposal 2-1, the transient period is defined within the indicated OFF period. Thus, NCR and gNB can configure the ON period and the OFF period in consideration of the transient period, and thus, the appropriate transfer operation can be controlled. Further, by defining the transient period within the indicated OFF period, the indicated ON period can be secured as the actual ON period.

### Option 3 of Proposal 2-1

In Option 3 of Proposal 2-1, a part of the transient period is defined within the indicated OFF period. Further, in Option 3 of Proposal 2-1, a part of the transient period is defined within the indicated ON period. In other words, the transient period is defined as being divided into a part within the indicated OFF period and a part within the indicated ON period. The partial transient period defined in the indicated OFF period and the partial transient period defined in the indicated ON period may be temporally continuous.

The transient period in the OFF period is the first time interval of X1 in the indicated OFF period. The transient period in the ON period is the last time interval of X2 in the indicated ON period. In this case, the actual ON period is a period obtained by excluding the transient period from the indicated ON period, and the actual OFF period is a period obtained by excluding the transient period from the indicated OFF period. In the example of Option 3 in FIG. 9, the actual ON period is a period obtained by excluding the last time interval of X2 from the indicated ON period, and the actual OFF period is a period obtained by excluding the first time interval of X1 from the indicated OFF period.

Note that, NCR-Fwd may be assumed to be turned ON in the actual ON period. NCR-Fwd may be assumed to be turned OFF in the actual OFF period. Alternatively, NCR-Fwd may be required to be turned ON in the actual ON period. Alternatively, NCR-Fwd may be required to be turned OFF in the actual OFF period. Note that the request to turn NCR-Fwd ON may be based on the actual ON period. The request to turn NCR-Fwd OFF may be based on the actual OFF period. In other words, NCR-Fwd need not be assumed to be turned ON or OFF in the transient period. Alternatively, NCR-Fwd need not be required to be turned ON or OFF in the transient period.

Here, X1 and X2, which are time intervals corresponding to the transient period, may be defined in advance, may be configured, or may be the subject of the Capability of NCR. Alternatively, X indicating the sum of X1 and X2 may be defined in advance, may be configured, or may be the subject of the Capability of NCR. In this case, X=X1+X2 may be applied. Further, in this case, X1=X2=0.5X may be applied, or X1 and X2 may be determined from X according to a specific ratio. Alternatively, X1 and X2 may depend on the implementation of NCR. For example, the ratio between X1 and X2 may be defined by the implementation of NCR, and X1 and X2 may be determined by considering the ratio with respect to a predetermined X.

Note that, in each option of Proposal 2-1 described above, the unit of the value (for example, X, X1, and X2) related to the transient period may be at least one of a slot, a symbol, a subframe, a second, a millisecond, and a microsecond.

In Option 3 of Proposal 2-1, the transient period is defined within the indicated OFF period and ON period. Thus, NCR and gNB can configure the ON period and the OFF period in consideration of the transient period, and thus, the appropriate transfer operation can be controlled.

Note that the option applied in each option of Proposal 2-1 described above may be defined in advance or configured. Alternatively, the applicability of each option may be the subject of the NCR capability.

Further, in each option of Proposal 2-1 described above, the time interval corresponding to the transient period may vary depending on the amount of the power of the NCR in the ON period. For example, the time interval corresponding to the transient period may be longer as the power of the NCR in the ON period increases.

### Proposal 2-2

In Proposal 2-2, it is assumed that the ON period and the OFF period are continuous with each other, as in Proposal 2-1. The NCR may be indicated with a pattern related to the ON period and the OFF period (hereinafter, sometimes abbreviated as an ON-OFF pattern). Further, the ON-OFF pattern may indicate that the ON period and the OFF period are continuous.

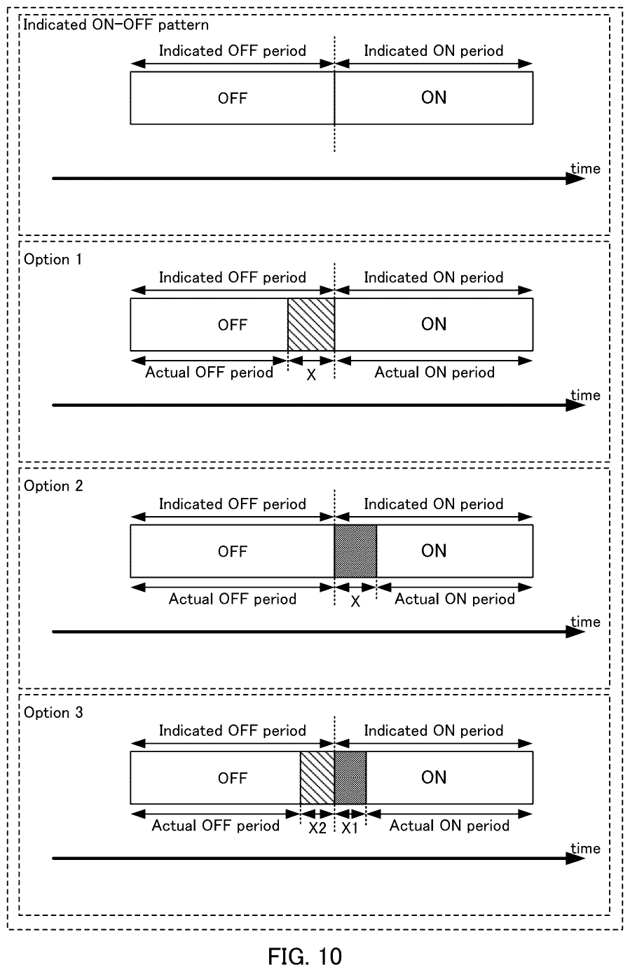

In Proposal 2-1, the transient period in the switching from ON to OFF has been described. In Proposal 2-2, on the other hand, three options for the transient period in the switching from OFF to ON is described with reference to FIG. 10. For the transient period in which the OFF period and the ON period are continuous, any of the three options may be adopted.

FIG. 10 is a diagram illustrating an example of a continuous OFF period and ON period. In the example of FIG. 10, the OFF period and the ON period in a case where the OFF period transitions to the ON period, that is, in a case where the NCR is switched from OFF to ON, are illustrated. For example, FIG. 10 illustrates the indicated ON-OFF patterns and the cases where Options 1 to 3 are applied to the indicated ON-OFF pattern.

The indicated ON-OFF pattern (referred to as “Indicated ON-OFF pattern” in the figure) shows that the indicated OFF period and the indicated ON period are continuous. Three options applied to this pattern will be described below.

### Option 1 of Proposal 2-2

In Option 1 of Proposal 2-2, the transient period is defined within the indicated OFF period. For example, as illustrated in the example of Option 1 in FIG. 10, the transient period is the last time interval of X in the indicated OFF period. In Option 1 of Proposal 2-2, the actual OFF period may be a time interval obtained by excluding the last time interval of X from the indicated OFF period.

Note that, NCR-Fwd may be assumed to be turned OFF in the actual OFF period. Alternatively, NCR-Fwd may be required to be turned OFF in the actual OFF period. Note that the request to turn NCR-Fwd OFF may be based on the actual OFF period. In other words, NCR-Fwd need not be assumed to be turned OFF or need not be required to be turned OFF in the transient period.

Here, X, which is a time interval corresponding to the transient period, may be defined in advance, may be configured, or may be the subject of the Capability of NCR.

In Option 1 of Proposal 2-2, the transient period is defined within the indicated OFF period. Thus, NCR and gNB can configure the ON period and the OFF period in consideration of the transient period, and thus, the appropriate transfer operation can be controlled. Further, by defining the transient period within the indicated OFF period, the indicated ON period can be secured as the actual ON period.

### Option 2 of Proposal 2-2

In Option 2 of Proposal 2-2, the transient period is defined within the indicated ON period. For example, as illustrated in the example of Option 2 in FIG. 10, the transient period is the first time interval of X in the indicated ON period. In Option 2 of Proposal 2-2, the actual ON period may be a time interval obtained by excluding the first time interval of X from the indicated ON period.

Note that, NCR-Fwd may be assumed to be turned ON in the actual ON period. Alternatively, NCR-Fwd may be required to be turned ON in the actual ON period. Note that the request to turn NCR-Fwd ON may be based on the actual ON period. In other words, NCR-Fwd need not be assumed to be turned ON or need not be required to be turned ON in the transient period.

Here, X, which is a time interval corresponding to the transient period, may be defined in advance, may be configured, or may be the subject of the Capability of NCR.

In Option 2 of Proposal 2-2, the transient period is defined within the indicated ON period. Thus, NCR and gNB can configure the ON period and the OFF period in consideration of the transient period, and thus, the appropriate transfer operation can be controlled. Further, defining the transient period within the indicated ON period shortens the length of the ON period, thereby reducing the power consumption of the NCR.

### Option 3 of Proposal 2-2

In Option 3 of Proposal 2-2, a part of the transient period is defined within the indicated ON period. Further, in Option 3 of Proposal 2-2, a part of the transient period is defined within the indicated OFF period. In other words, the transient period is defined as being divided into a part within in the indicated ON period and a part within the indicated OFF period. The partial transient period defined in the indicated ON period and the partial transient period defined in the indicated OFF period may be temporally continuous.

The transient period in the ON period is the first time interval of X1 in the indicated ON period. The transient period in the OFF period is the last time interval of X2 in the indicated OFF period. In this case, the actual OFF period is a period obtained by excluding the transient period from the indicated OFF period, and the actual ON period is a period obtained by excluding the transient period from the indicated ON period. In the example of Option 3 in FIG. 10, the actual OFF period is a period obtained by excluding the last time interval of X2 from the indicated OFF period, and the actual ON period is a period obtained by excluding the first time interval of X1 from the indicated ON period.

Note that, NCR-Fwd may be assumed to be turned OFF in the actual OFF period. NCR-Fwd may be assumed to be turned ON in the actual ON period. Alternatively, NCR-Fwd may be required to be turned OFF in the actual OFF period. Alternatively, NCR-Fwd may be required to be turned ON in the actual ON period. Note that the request to turn NCR-Fwd OFF may be based on the actual OFF period. The request to turn NCR-Fwd ON may be based on the actual ON period. In other words, NCR-Fwd need not be assumed to be turned OFF or ON in the transient period. Alternatively, NCR-Fwd need not be required to be turned OFF or ON in the transient period.

Here, X1 and X2, which are time intervals corresponding to the transient period, may be defined in advance, may be configured, or may be the subject of the Capability of NCR. Alternatively, X indicating the sum of X1 and X2 may be defined in advance, may be configured, or may be the subject of the Capability of NCR. In this case, X=X1+X2 may be applied. Further, in this case, X1=X2=0.5X may be applied, or X1 and X2 may be determined from X according to a specific ratio. Alternatively, X1 and X2 may depend on the implementation of NCR. For example, the ratio between X1 and X2 may be defined by the implementation of NCR, and X1 and X2 may be determined by considering the ratio with respect to a predetermined X.

Note that, in each option of Proposal 2 -2 described above, the unit of the value (for example, X, X1, and X2) related to the transient period may be at least one of a slot, a symbol, a subframe, a second, a millisecond, and a microsecond.

In Option 3 of Proposal 2-2, the transient period is defined within the indicated OFF period and ON period. Thus, NCR and gNB can configure the ON period and the OFF period in consideration of the transient period, and thus, the appropriate transfer operation can be controlled.

Note that the option applied in each option in Proposal 2 -2 described above may be defined in advance or configured. Alternatively, the applicability of each option may be the subject of the NCR capability.

Further, each option of Proposal 2-1 described above and each option of Proposal 2 -2 may be used in combination. For example, by combining Option 2 of Proposal 2-1 and Option 1 of Proposal 2-2, in a case where the OFF periods are temporally present in both the front and rear of the ON period, the transient period may be defined within the OFF period in both the front and rear. Accordingly, the indicated ON period is the ON period, and thus, the appropriate transfer operation can be controlled. Note that each option in Proposal 2-1 and each option in Proposal 2 -2 may be collectively defined in advance or configured.

Further, the time interval corresponding to the transient period in the case of switching from ON to OFF as shown in Proposal 2-1 and the time interval corresponding to the transient period in the case of switching from OFF to ON as shown in Proposal 2 -2 may be the same or different. Further, the time interval corresponding to the transient period may vary depending on the amount of the power of the NCR in the ON period. For example, the time interval corresponding to the transient period may be longer as the power of the NCR in the ON period increases.

As described above, Proposal 2 defines a transient period in a case where the operation of NCR (for example, the operation of NCR-Fwd) is switched from ON to OFF (or from OFF to ON). Accordingly, it is possible to consider the time required for the operation of NCR (for example, the operation of NCR-Fwd) to switch from ON to OFF (or from OFF to ON), and the switching can be performed at an appropriate time, thereby enabling the transfer operation to be appropriately controlled.

For example, by considering the time required for switching, it is possible to avoid a recognition discrepancy regarding the ON/OFF state between the side that indicates switching (for example, NW) and the NCR that receives the indication. Thus, for example, it is possible to avoid a state in which the transfer operation between the NCR and the gNB cannot be appropriately controlled by assuming that the NCR is in the ON state even though the NCR is not in the ON state.

For example, in Proposal 2, when NCR switches the state from a second state (for example, an OFF state) different from a first state (for example, an ON state) to the first state, NCR configures a specific period (for example, a transient period) between a period of the second state (for example, OFF period) and a period of the first state (ON period). Note that the specific period may be defined based on the time required for switching from the second state to the first state.

### Proposal 3

In Proposal 2, an example of defining the transient period when the operation of NCR (for example, the operation of NCR-Fwd) is switched from ON to OFF (or from OFF to ON) in a case where the ON period and the OFF period are continuous with each other has been described. In Proposal 3, an example of defining the transient period when the operation of NCR (for example, the operation of NCR-Fwd) is switched from ON to OFF (or from OFF to ON) in a case where the ON period and the OFF period are not continuous with each other is described.

Note that, in Proposal 3, the ON period and the OFF period being not continuous with each other corresponds to a gap period being provided between the ON period and the OFF period.

### Proposal 3-1

In Proposal 3-1, it is assumed that the ON period and the OFF period are not continuous. The NCR may be indicated with a pattern related to the ON period and the OFF period (hereinafter, sometimes abbreviated as an ON-OFF pattern). Further, the ON-OFF pattern may indicate that the ON period and the OFF period are not continuous.

In a case where an ON-OFF pattern in which the ON period and the OFF period are discontinuous (which may be referred to as a discontinuous ON-OFF pattern) is indicated to NCR, a gap (gap period) between the ON period and the OFF period may mean a time width for NCR to switch from ON to OFF. For the gap period, neither ON nor OFF may be indicated.

Note that the gap period may mean a time width for switching from ON to OFF, or may mean a time other than the time for switching from ON to OFF. Further, the gap period may include a time width for switching from ON to OFF and a time other than the time for switching from ON to OFF.

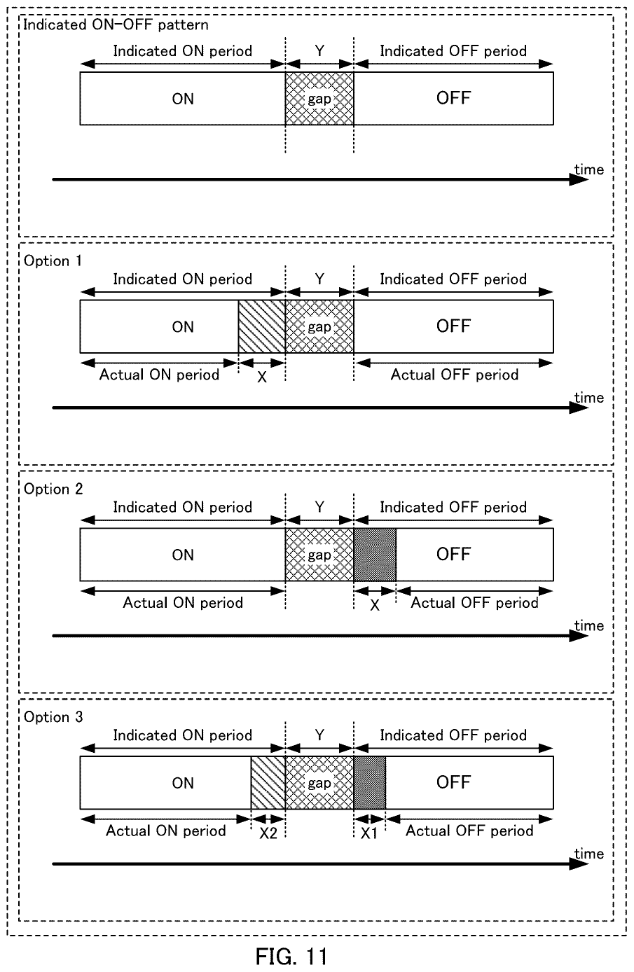

For the transient period in the switching from ON to OFF, three options will be described below with reference to FIG. 11.

FIG. 11 is a diagram illustrating an example of a non-continuous ON period and OFF period. In the example of FIG. 11, a gap period is provided between the ON period and the OFF period. Further, in the example of FIG. 11, it is illustrated that the ON period transitions to the OFF period across the gap period, that is, NCR is switched from ON to OFF. For example, FIG. 11 illustrates the indicated ON-OFF patterns and the cases where Options 1 to 3 are applied to the indicated ON-OFF pattern.

In the indicated ON-OFF pattern (referred to as “Indicated ON-OFF pattern” in the figure), a gap period is provided between the indicated ON period and the indicated OFF period, indicating that the indicated ON period and the indicated OFF period are not continuous. Three options applied to this pattern will be described below.

### Option 1 of Proposal 3-1

In Option 1 of Proposal 3-1, the transient period is defined within the indicated ON period, similarly to Option 1 of Proposal 2-1. For example, as illustrated in the example of Option 1 in FIG. 11, the transient period is the last time interval of X in the indicated ON period. In Option 1 of Proposal 3-1, the actual ON period may be a time interval obtained by excluding the last time interval of X from the indicated ON period.

Note that, NCR-Fwd may be assumed to be turned ON in the actual ON period. Alternatively, NCR-Fwd may be required to be turned ON in the actual ON period. Note that the request to turn NCR-Fwd ON may be based on the actual ON period. In other words, NCR-Fwd need not be assumed to be turned ON or need not be required to be turned ON in the transient period.

Here, X, which is a time interval corresponding to the transient period, may be defined in advance, may be configured, or may be the subject of the Capability of NCR.

Note that X may indicate the length of the transient period or the length of the transient period excluding the gap period. Further, in a case where the gap period is longer than the transient period, X may be zero.

In Option 1 of Proposal 3-1, the transient period is defined within the indicated ON period. Thus, NCR and gNB can configure the ON period and the OFF period in consideration of the transient period, and thus, the appropriate transfer operation can be controlled. Further, defining the transient period within the indicated ON period shortens the length of the ON period, thereby reducing the power consumption of the NCR.

### Option 2 of Proposal 3-1

In Option 2 of Proposal 3-1, the transient period is defined within the indicated OFF period, similarly to Option 2 of Proposal 2-1. For example, as illustrated in the example of Option 2 in FIG. 11, the transient period is the first time interval of X in the indicated OFF period. In Option 2 of Proposal 3-1, the time interval obtained by excluding the first time interval of X from the indicated OFF period may be the actual OFF period.

Note that, NCR-Fwd may be assumed to be turned OFF in the actual OFF period. Alternatively, NCR-Fwd may be required to be turned OFF in the actual OFF period. Note that the request to turn NCR-Fwd OFF may be based on the actual OFF period. In other words, NCR-Fwd need not be assumed to be turned OFF or need not be required to be turned OFF in the transient period.

Here, X, which is a time interval corresponding to the transient period, may be defined in advance, may be configured, or may be the subject of the Capability of NCR.

Note that X may indicate the length of the transient period or the length of the transient period excluding the gap period. Further, in a case where the gap period is longer than the transient period, X may be zero.

In Option 2 of Proposal 3-1, the transient period is defined within the indicated OFF period. Thus, NCR and gNB can configure the ON period and the OFF period in consideration of the transient period, and thus, the appropriate transfer operation can be controlled. Further, by defining the transient period within the indicated OFF period, the indicated ON period can be secured as the actual ON period.

### Option 3 of Proposal 3-1

In Option 3 of Proposal 3-1, similarly to Option 3 of Proposal 2-1, a part of the transient period is defined within the indicated OFF period. In Option 3 of Proposal 3-1, a part of the transient period is defined within the indicated ON period. In other words, the transient period is defined as being divided into a part within the indicated OFF period and a part within the indicated ON period. The partial transient period defined in the indicated OFF period and the partial transient period defined in the indicated ON period need not be temporally continuous.

The transient period in the OFF period is the first time interval of X1 in the indicated OFF period. The transient period in the ON period is the last time interval of X2 in the indicated ON period. In this case, the actual ON period is a period obtained by excluding the transient period from the indicated ON period, and the actual OFF period is a period obtained by excluding the transient period from the indicated OFF period. In the example of Option 3 in FIG. 11, the actual ON period is a period obtained by excluding the last interval of X2 from the indicated ON period, and the actual OFF period is a period obtained by excluding the first time interval of X1 from the indicated OFF period.

Note that, NCR-Fwd may be assumed to be turned ON in the actual ON period. NCR-Fwd may be assumed to be turned OFF in the actual OFF period. Alternatively, NCR-Fwd may be required to be turned ON in the actual ON period. Alternatively, NCR-Fwd may be required to be turned OFF in the actual OFF period. Note that the request to turn NCR-Fwd ON may be based on the actual ON period. The request to turn NCR-Fwd OFF may be based on the actual OFF period. In other words, NCR-Fwd need not be assumed to be turned ON or OFF in the transient period. Alternatively, NCR-Fwd need not be required to be turned ON or OFF in the transient period.

Here, X1 and X2, which are time intervals corresponding to the transient period, may be defined in advance, may be configured, or may be the subject of the Capability of NCR. Alternatively, X indicating the sum of X1 and X2 may be defined in advance, may be configured, or may be the subject of the Capability of NCR. In this case, X=X1+X2 may be applied. Further, in this case, X1=X2=0.5X may be applied, or X1 and X2 may be determined from X according to a specific ratio. Alternatively, X1 and X2 may depend on the implementation of NCR. For example, the ratio between X1 and X2 may be defined by the implementation of NCR, and X1 and X2 may be determined by considering the ratio with respect to a predetermined X.

Note that X may indicate the length of the transient period or the length of the transient period excluding the gap period. Further, in a case where the gap period is longer than the transient period, X may be zero. Alternatively, X may indicate the sum of X1, X2, and the length of the gap period. In this case, X1 and X2 may be determined from a length obtained by subtracting the length of the gap period from the length of X.

Note that, in Options 1 to 3 of Proposal 3-1 described above, in a case where the gap between the time at the end of the indicated ON period and the time at the start of the indicated OFF period is Y time interval, the value for Y may be predefined, may be configured, or may be the subject of the capability of NCR. The value for Y may be, for example, Y itself or the sum of X and Y (for example, Z in Z=X+Y). Alternatively, the value for Y may be the sum of X1, X2, and Y in Option 3 (for example, Z in Z=X1+X2+Y).

In Option 3 of Proposal 3-1, the transient period is defined within the indicated OFF period and ON period. Thus, NCR and gNB can configure the ON period and the OFF period in consideration of the transient period, and thus, the appropriate transfer operation can be controlled.

As described above, Options 1 to 3 of Proposal 3-1 may be the same as those of Proposal 2-1 except for the presence of a gap period. In Proposal 3-1, any of the following two options may be further applied.

### Option 4 of Proposal 3-1

In Option 4 of Proposal 3-1, it may be assumed that there is a limitation on the magnitude relationship between the gap between the time of the end of the indicated ON period and the time of the start of the indicated OFF period and a specific value. For example, NCR may assume that the gap between the time of the end of the indicated ON period and the time of the start of the indicated OFF period is greater than a specific value or is equal to or greater than the specific value. Here, the time of the end of the indicated ON period may be, for example, the last symbol of the indicated ON period or the last slot of the indicated ON period. Further, the time of the start of the indicated OFF period may be, for example, the first symbol of the indicated OFF period or the first slot of the indicated OFF period. Further, the specific value may be defined in advance or configured. Alternatively, the specific value may be the subject of the Capability of NCR.

The specific value may correspond to the length of the transient period or may be determined based on the transient period. For example, the specific value may be a value obtained by multiplying or dividing the length of the transient period by a specific coefficient, or a value obtained by adding or subtracting the specific value to or from the length of the transient period. Further, for example, the specific value may be a value obtained by performing an operation on the length of the transient period such that the specific value is an integer multiple of a specific time length. For example, the specific value may be a value obtained by multiplying the length of the transient period by a specific coefficient such that the specific value is an integer multiple of a specific time length, and/or by adding a specific addition value to the length of the transient period. Note that the specific time length may be the length in a specific time unit such as a symbol length, a slot length, or a subframe length.

Note that, in Option 4 of Proposal 3-1, NCR does not need to assume that the gap between the time of the end of the indicated ON period and the time of the start of the indicated OFF period is less than a specific value or is equal to or less than a specific value. Further, in Option 4 of Proposal 3-1, NW indicates that the gap between the time of the end of the ON period and the time of the start of the indicated OFF period is greater than a specific value or is equal to or greater than the specific value.

In Option 4 of Proposal 3-1, it is assumed that there is a limitation on the magnitude relationship between the gap between the time of the end of the indicated ON period and the time of the start of the indicated OFF period and a specific value. Thus, it is possible to secure the time required to switch from ON to OFF in a gap equal to or greater than a specific value, and to control an appropriate transfer operation.

### Option 5 of Proposal 3-1

In Option 5 of Proposal 3-1, it need not be assumed that there is a limitation on the magnitude relationship between the gap between the time of the end of the indicated ON period and the time of the start of the indicated OFF period and a specific value. Further, in Option 5 of Proposal 3-1, NCR ignores the indication in a case where the gap between the time of the end of the indicated ON period and the time of the start of the indicated OFF period is less than a specific value or is equal to or less than the specific value. In the case of ignoring the indication, NCR maintains the ON state.

The time of the end of the indicated ON period, the time of the start of the indicated OFF, and the specific value in Option 5 of Proposal 3-1 may be the same as those in Option 4 of Proposal 3-1.

Note that, in each option of Proposal 3-1 described above, the unit of the value (for example, X, X1, X2, Y, and Z) related to the transient period may be at least one of a slot, a symbol, a subframe, a second, a millisecond, and a microsecond.

In Option 5 of Proposal 3-1, NCR ignores the indication in a case where the gap between the time of the end of the indicated ON period and the time of the start of the indicated OFF period is less than a specific value or is equal to or less than the specific value. Thus, in a case where the time required for NCR to switch from ON to OFF cannot be secured, it is possible to select an operation of not switching to OFF, and thus, it is possible to control an appropriate relay operation (transfer operation).

Note that, in Proposal 3-1, when a sufficient gap period (for example, a gap period longer than the transient period) is provided, the transient period need not be considered. For example, the gap period in Proposal 3-1 may be a period based on the time required for NCR to switch from ON to OFF, or may be a period configured by NW (for example, gNB). Further, the gap period may indicate a period between an ON period and an OFF period configured by NW (for example, gNB). The transient period may indicate the time required for NCR to switch from ON to OFF. For example, in a case where the gap period is configured by NW (for example, gNB) as a time longer than the time required for NCR to switch from ON to OFF, the transient period need not be considered.

### Proposal 3-2

In Proposal 3-2, it is assumed, as in Proposal 3-1, that the ON period and the OFF period are not continuous. The NCR may be indicated with a pattern (ON-OFF pattern) related to the ON period and the OFF period. Further, the ON-OFF pattern may indicate that the ON period and the OFF period are not continuous.

In Proposal 3-1, in a case where an ON-OFF pattern (discontinuous ON-OFF pattern) in which the ON period and the OFF period are discontinuous is indicated to NCR, the gap between the ON period and the OFF period means a time width for NCR to switch from ON to OFF. In Proposal 3-2, when a discontinuous ON-OFF pattern is indicated to NCR, the gap between the OFF period and the ON period means the time width for NCR to switch from OFF to ON. Note that, for the gap period, neither ON nor OFF may be indicated.

Note that the gap period may mean a time width for switching from OFF to ON, or may mean a time other than the time for switching from OFF to ON. Further, the gap period may include a time width for switching from OFF to ON and a time other than the time for switching from OFF to ON.

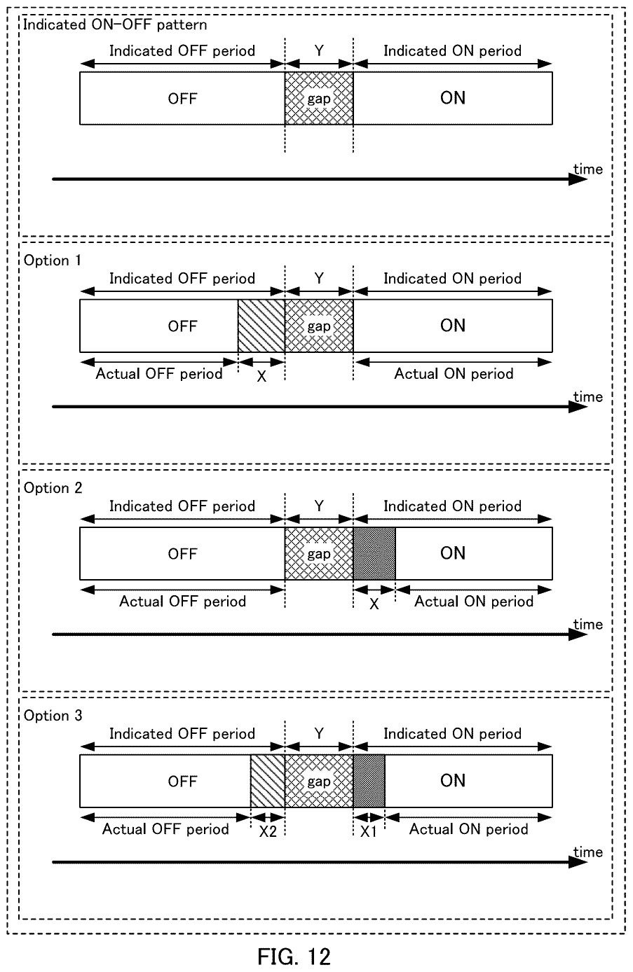

For the transient period in the switching from OFF to ON, three options will be described below with reference to FIG. 12.

FIG. 12 is a diagram illustrating an example of a non-continuous OFF period and an ON period. In the example of FIG. 12, a gap period is provided between the OFF period and the ON period. Further, the example of FIG. 12 illustrates that the OFF period transitions to the ON period across the gap period, that is, NCR is switched from OFF to ON. For example, FIG. 12 illustrates the indicated ON-OFF patterns and the cases where Options 1 to 3 are applied to the indicated ON-OFF pattern.

In the indicated ON-OFF pattern (“Indicated ON-OFF pattern” in the figure), a gap period is provided between the indicated OFF period and the indicated ON period, indicating that the indicated OFF period and the indicated ON period are not continuous. Three options applied to this pattern will be described below.

### Option 1 of Proposal 3-2

In Option 1 of Proposal 3-2, the transient period is defined within the indicated OFF period, similarly to Option 1 of Proposal 2-2. For example, as illustrated in the example of Option 1 in FIG. 12, the transient period is the last time interval of X in the indicated OFF period. In Option 1 of Proposal 3-2, the actual OFF period may be a time interval obtained by excluding the last time interval of X from the indicated OFF period.

Note that, NCR-Fwd may be assumed to be turned OFF in the actual OFF period. Alternatively, NCR-Fwd may be required to be turned OFF in the actual OFF period. Note that the request to turn NCR-Fwd OFF may be based on the actual OFF period. In other words, NCR-Fwd need not be assumed to be turned OFF or need not be required to be turned OFF in the transient period.

Here, X, which is a time interval corresponding to the transient period, may be defined in advance, may be configured, or may be the subject of the Capability of NCR.

Note that X may indicate the length of the transient period or the length of the transient period excluding the gap period. Further, in a case where the gap period is longer than the transient period, X may be zero.

In Option 1 of Proposal 3-2, the transient period is defined within the indicated OFF period. Thus, NCR and gNB can configure the ON period and the OFF period in consideration of the transient period, and thus, the appropriate transfer operation can be controlled. Further, by defining the transient period within the indicated OFF period, the indicated ON period can be secured as the actual ON period.

### Option 2 of Proposal 3-2

In Option 2 of Proposal 3-2, the transient period is defined within the indicated ON period, similarly to Option 2 of Proposal 2-2. For example, as illustrated in the example of Option 2 in FIG. 12, the transient period is the first time interval of X in the indicated ON period. In Option 2 of Proposal 3-2, the time interval obtained by excluding the first time interval of X from the indicated ON period may be the actual ON period.

Note that, NCR-Fwd may be assumed to be turned ON in the actual ON period. Alternatively, NCR-Fwd may be required to be turned ON in the actual ON period. Note that the request to turn NCR-Fwd ON may be based on the actual ON period. In other words, NCR-Fwd need not be assumed to be turned ON or need not be required to be turned ON in the transient period.

Here, X, which is a time interval corresponding to the transient period, may be defined in advance, may be configured, or may be the subject of the Capability of NCR.

Note that X may indicate the length of the transient period or the length of the transient period excluding the gap period. Further, in a case where the gap period is longer than the transient period, X may be zero.

In Option 2 of Proposal 3-2, the transient period is defined within the indicated ON period. Thus, NCR and gNB can configure the ON period and the OFF period in consideration of the transient period, and thus, the appropriate transfer operation can be controlled. Further, defining the transient period within the indicated ON period shortens the length of the ON period, thereby reducing the power consumption of the NCR.

### Option 3 of Proposal 3-2

In Option 3 of Proposal 3-2, a part of the transient period is defined within the indicated ON period, similarly to Option 3 of Proposal 2-2. In Option 3 of Proposal 3-2, a part of the transient period is defined within the indicated OFF period. In other words, the transient period is defined as being divided into a part within the indicated ON period and a part within the indicated OFF period. The partial transient period defined in the indicated ON period and the partial transient period defined in the indicated OFF period need not be temporally continuous.

The transient period in the ON period is the first time interval of X1 in the indicated ON period. The transient period in the OFF period is the last time interval of X2 in the indicated OFF period. In this case, the actual OFF period is a period obtained by excluding the transient period from the indicated OFF period, and the actual ON period is a period obtained by excluding the transient period from the indicated ON period. In the example of Option 3 in FIG. 12, the actual OFF period is a period obtained by excluding the last time interval of X2 from the indicated OFF period, and the actual ON period is a period obtained by excluding the first time interval of X1 from the indicated ON period.

Note that, NCR-Fwd may be assumed to be turned OFF in the actual OFF period. NCR-Fwd may be assumed to be turned ON in the actual ON period. Alternatively, NCR-Fwd may be required to be turned OFF in the actual OFF period. Alternatively, NCR-Fwd may be required to be turned ON in the actual ON period. Note that the request to turn NCR-Fwd OFF may be based on the actual OFF period. The request to turn NCR-Fwd ON may be based on the actual ON period. In other words, NCR-Fwd need not be assumed to be turned OFF or ON in the transient period. Alternatively, NCR-Fwd need not be required to be turned OFF or ON in the transient period.

Here, X1 and X2, which are time intervals corresponding to the transient period, may be defined in advance, may be configured, or may be the subject of the Capability of NCR. Alternatively, X indicating the sum of X1 and X2 may be defined in advance, may be configured, or may be the subject of the Capability of NCR. In this case, X=X1+X2 may be applied. Further, in this case, X1=X2=0.5X may be applied, or X1 and X2 may be determined from X according to a specific ratio. Alternatively, X1 and X2 may depend on the implementation of NCR. For example, the ratio between X1 and X2 may be defined by the implementation of NCR, and X1 and X2 may be determined by considering the ratio with respect to a predetermined X.

Note that X may indicate the length of the transient period or the length of the transient period excluding the gap period. Further, in a case where the gap period is longer than the transient period, X may be zero. Alternatively, X may indicate the sum of X1, X2, and the length of the gap period. In this case, X1 and X2 may be determined from a length obtained by subtracting the length of the gap period from the length of X.

Note that, in Options 1 to 3 of Proposal 3-2 described above, in a case where the gap between the time of the end of the indicated OFF period and the time of the start of the indicated ON period is Y time interval, the value for Y may be predefined, may be configured, or may be the subject of the capability of the NCR. The value for Y may be, for example, Y itself or the sum of X and Y (for example, Z in Z=X +Y). Alternatively, the value for Y may be the sum of X1, X2, and Y in Option 3 (for example, Z in Z=X1+X2+Y).

In Option 3 of Proposal 3-2, the transient period is defined within the indicated OFF period and ON period. Thus, NCR and gNB can configure the ON period and the OFF period in consideration of the transient period, and thus, the appropriate transfer operation can be controlled.

Note that the option applied in each option of Proposal 3-2 described above may be defined in advance or configured. Alternatively, the applicability of each option may be the subject of the NCR capability.

Further, each option of Proposal 3-1 described above and each option of Proposal 3-2 may be used in combination. For example, by combining Option 2 of Proposal 3-1 and Option 1 of Proposal 3-2, in a case where the OFF periods are temporally present in both the front and rear of the ON period, the transient period may be defined within the OFF period in both the front and rear. Accordingly, the indicated ON period is the ON period, and thus, the appropriate transfer operation can be controlled. Note that each option in Proposal 3-1 and each option in Proposal 3-2 may be associated together and may be defined in advance or configured.

As described above, Options 1 to 3 of Proposal 3-2 are the same as those in Proposal 2-2. In Proposal 3-2, any of the following two options may be further applied.

### Option 4 of Proposal 3-2

In Option 4 of Proposal 3-2, it may be assumed that there is a limitation on the magnitude relationship between the gap between the time of the end of the indicated ON period and the time of the start of the indicated OFF period and a specific value. For example, NCR may assume that the gap between the time of the end of the indicated OFF period and the time of the start of the indicated ON period is greater than a specific value or is equal to or greater than the specific value. Here, the time of the end of the indicated OFF period may be, for example, the last symbol of the indicated OFF period or the last slot of the indicated OFF period. Further, the time of the start of the indicated ON period may be, for example, the first symbol of the indicated ON period or the first slot of the indicated ON period. Further, the specific value may be defined in advance or configured. Alternatively, the specific value may be the subject of the Capability of NCR.

The specific value may correspond to the length of the transient period or may be determined based on the transient period. For example, the specific value may be a value obtained by multiplying or dividing the length of the transient period by a specific coefficient, or a value obtained by adding or subtracting the specific value to or from the length of the transient period. Further, for example, the specific value may be a value obtained by performing an operation on the length of the transient period such that the specific value is an integer multiple of a specific time length. For example, the specific value may be a value obtained by multiplying the length of the transient period by a specific coefficient such that the specific value is an integer multiple of a specific time length, and/or by adding a specific addition value to the length of the transient period. Note that the specific time length may be the length of a specific time unit such as a symbol length, a slot length, or a subframe length.

Note that, in Option 4 of Proposal 3-2, NCR does not need to assume that the gap between the time of the end of the indicated OFF period and the time of the start of the indicated ON period is less than a specific value or is equal to or less than a specific value. Further, in Option 4 of Proposal 3-2, NW indicates that the gap between the time of the end of the OFF period and the time of the start of the indicated ON period is greater than a specific value or is equal to or greater than the specific value.

In Option 4 of Proposal 3-2, it is assumed that there is a limitation on the magnitude relationship between the gap between the time of the end of the indicated ON period and the time of the start of the indicated OFF period and a specific value. Thus, it is possible to secure the time required to switch from OFF to ON in a gap equal to or greater than a specific value, and to control an appropriate transfer operation.

### Option 5 of Proposal 3-2

In Option 5 of Proposal 3-2, it need not be assumed that there is a limitation on the magnitude relationship between the gap between the time of the end of the indicated OFF period and the time of the start of the indicated ON period and a specific value. Further, in Option 5 of Proposal 3-2, in a case where the gap between the time of the end of the indicated OFF period and the time of the start of the indicated ON period is less than a specific value or is equal to or less than the specific value, NCR ignores the indication. In a case where the indication is ignored, NCR maintains the OFF state.

The time of the end of the indicated OFF period, the time of the start of the indicated ON period, and the specific value in Option 5 of Proposal 3-2 may be the same as those in Option 4 of Proposal 3-2.

Note that, in each option of Proposal 3-2 described above, the unit of the value (for example, X, X1, X2, Y, and Z) related to the transient period may be at least one of a slot, a symbol, a subframe, a second, a millisecond, and a microsecond.

In Option 5 of Proposal 3-2, NCR ignores the indication in a case where the gap between the time of the end of the indicated OFF period and the time of the start of the indicated ON period is less than a specific value or is equal to or less than the specific value. Thus, in a case where the time required for NCR to switch from OFF to ON cannot be secured, it is possible to select an operation of not switching to ON, and thus, it is possible to control an appropriate relay operation (transfer operation).

Note that, in Proposal 3-2, when a sufficient gap period (for example, a gap period longer than the transient period) is provided, the transient period need not be considered. For example, the gap period in Proposal 3-2 may be a period based on the time required for NCR to switch from OFF to ON, or may be a period configured by NW (for example, gNB). Further, the gap period may indicate a period between an OFF period and an ON period configured by NW (for example, gNB). The transient period may indicate the time required for NCR to switch from OFF to ON. For example, in a case where the gap period is configured by NW (for example, gNB) as a time longer than the time required for NCR to switch from OFF to ON, the transient period need not be considered.

Further, the time interval corresponding to the transient period in the case of switching from ON to OFF as shown in Proposal 3-1 and the time interval corresponding to the transient period in the case of switching from OFF to ON as shown in Proposal 3-2 may be the same or may be different. Further, the time interval corresponding to the transient period may vary depending on the amount of the power of the NCR in the ON period. For example, the time interval corresponding to the transient period may be longer as the power of the NCR in the ON period increases.

As described above, in Proposal 3, a transient period in a case where the operation of NCR (for example, the operation of NCR-Fwd) switches from ON to OFF (or from OFF to ON) is defined. Thus, it is possible to consider the time required for the operation of NCR (for example, the operation of NCR-Fwd) to switch from ON to OFF (or from OFF to ON), and the switching is performed at an appropriate time, thereby enabling the transfer operation to be appropriately controlled.

For example, by considering the time required for switching, it is possible to avoid a recognition discrepancy regarding the ON/OFF state between the side that gives the switching indication (for example, NW) and the NCR that receives the indication. Thus, for example, it is possible to avoid a state in which the transfer operation between the NCR and the gNB cannot be appropriately controlled by assuming that the NCR is in the ON state even though the NCR is not in the ON state.

### Proposal 4

As shown in Proposal 3, a gap period is possibly provided between the ON period and the OFF period.

NCR possibly receives an indication of a resource indicating an ON period and an OFF period, and it may be implicitly indicated that the period between the ON period and the OFF period configured based on the indication is a gap. In this case, since the gap period is not explicitly indicated, NCR possibly misrecognizes the gap period. In a case where the NCR misrecognizes the gap period, for example, in a case where the NCR misrecognizes a certain ON period as a gap period, the certain period is not in an ON state, and the transfer is not performed, which deteriorates the communication quality. Further, in a case where NCR misrecognizes, for example, a certain OFF period as a gap period, the certain period is not in an OFF state, and an operation of transferring a signal is caused, which causes interference.

Accordingly, in Proposal 4, a method for indicating a resource including a gap period will be described.

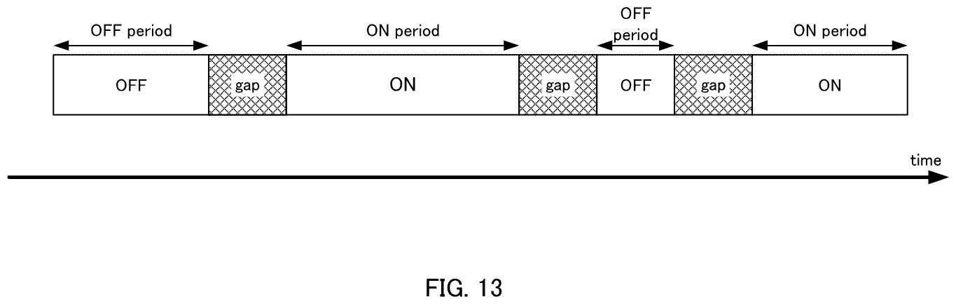

FIG. 13 is a diagram illustrating examples of an ON period, an OFF period, and a gap period. The gap between the ON period and the OFF period may mean a time width for NCR to switch from ON to OFF or a time width for NCR to switch from OFF to ON, as described in Proposal 3. For the gap period, neither ON nor OFF may be indicated. The gap period may be regarded as another state different from ON and OFF.

### Option 1 of Proposal 4

In Option 1 of Proposal 4, a list of time units related to the ON period, the OFF period, and the gap period is indicated. For example, a list of ON-OFF-gap for a time resource is indicated. For example, an ON-OFF-gap indicator may be indicated for each time unit.

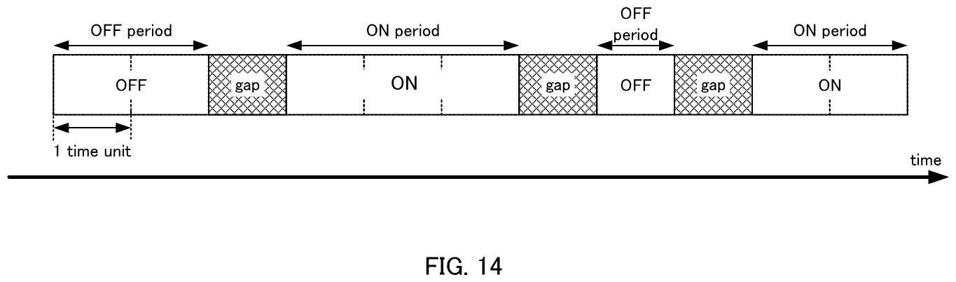

FIG. 14 is a diagram illustrating examples of an ON period, an OFF period, and a gap period distinguished in a time unit. As illustrated in FIG. 14, the ON period, the OFF period, and the gap period each have a duration of one or a plurality of time units. In NCR, an indicator (“ON-OFF-gap indicator”) indicating whether each time unit is an ON period, an OFF period, or a gap period may be indicated. Further, for example, a list of time units (in FIG. 14, a list composed of 11 time units) may be indicated. In other words, the list of time units indicates one or more time units (11 time units in FIG. 14) in a certain specific time interval. Then, the ON-OFF-gap indicator may indicate whether each time unit (in FIG. 14, each of the 11 time units) is an ON period, an OFF period, or a gap period.

Note that the indication of the indicator of the ON-OFF-gap may be performed by RRC signaling, MAC CE signaling, or DCI.

The list of time units may be indicated as the number of continuous time units by the start timing and the time length. Alternatively, the list of time units may be indicated as a list of identifiers (IDs) of time units.

The list of time units may be defined in advance. For example, the start timing and/or the time length may be defined in advance.

### Option 1A of Proposal 4

A plurality of ON-OFF-gap patterns described above may be indicated to NCR by gNB (or NW). One certain pattern among the plurality of ON-OFF-gap patterns may be indicated to NCR by gNB (or NW). The indication of each pattern may be performed by RRC signaling, MAC CE signaling, or DCI. Each of the plurality of patterns may be indicated in the same manner as in Option 1 of Proposal 4.

Note that the time unit may be at least one of a slot, a symbol, a subframe, a subframe group, a slot group, and a symbol group. The subframe group may be a group including one or more subframes. The slot group may be a group including one or more slots. The symbol group may be a group including one or more symbols.

### Option 2 of Proposal 4

In Option 2 of Proposal 4, the periodic pattern of the ON period, the OFF period, and the gap period is indicated by gNB. For example, the period and offset of the pattern may be indicated. For example, a list of ON-OFF-gap for a time resource is indicated. For example, the ON-OFF-gap indicator may be indicated for each time unit within the period of the pattern.

For example, information indicating one periodic pattern (a list of ON-OFF-gap and/or an ON-OFF-gap indicator), the period of the pattern, and the offset of the pattern (for example, the offset from a certain time point to the start timing and/or the offset from a certain time point to the end timing) may be indicated.

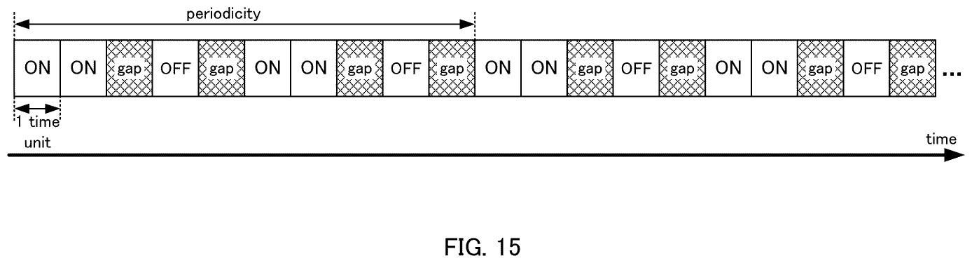

FIG. 15 is a diagram illustrating examples of an ON period, an OFF period, and a gap period distinguished in a time unit. As illustrated in FIG. 15, the ON period, the OFF period, and the gap period each have a duration of one or more time units. Then, a pattern including an ON period, an OFF period, and a gap period is periodically repeated.

An ON-OFF-gap indicator indicating whether each time unit is an ON period, an OFF period, or a gap period may be indicated to NCR.

Note that the indication of the ON-OFF-gap indicator may be performed by RRC signaling, MAC CE signaling, or DCI.

The granularity of the offset and the period may be in a subframe unit, slot unit, or symbol unit. Alternatively, the granularity of the offset and the period may be in a subframe group unit, slot group unit, or symbol group unit.

The period and offset of the pattern may be defined in advance.

### Option 2A of Proposal 4

A plurality of periodic patterns of the ON-OFF-gap described above may be indicated to NCR by gNB (or NW). A certain pattern from the plurality of periodic patterns of the ON-OFF-gap may be indicated to NCR by gNB (or NW). The indication of each pattern may be performed by RRC signaling, MAC CE signaling, or DCI. Each of the plurality of patterns may be indicated in the same manner as in Option 2 of Proposal 4.

Note that the time unit may be at least one of a slot, a symbol, a subframe, a subframe group, a slot group, and a symbol group. The subframe group may be a group including one or more subframes. The slot group may be a group including one or more slots. The symbol group may be a group including one or more symbols.

As described above, in Proposal 4, a method has been described in which the gap period is explicitly indicated. By this method, NCR can avoid misrecognizing the gap period, thereby avoiding communication quality degradation due to an inappropriate transfer operation and/or avoiding unnecessary transfer operations that cause interference.

For example, in Proposal 4, NCR switches from the second state to the first state based on information (for example, an ON-OFF-gap indicator and/or a list of ON-OFF-gap) indicating the temporal arrangement of a period of the first state (for example, an ON period), a specific period (for example, a gap period), and a period of the second state (for example, an OFF period).

### Proposal 5

As described above, a switching between ON and OFF occurs in NCR. Frequent occurrence of the switching is preferred to be avoided.

For example, as described above, in the switching between ON and OFF, a gap occurs between the time when NCR receives an indication to be turned ON and the time when NCR is actually turned ON in accordance with the indication. This gap is not a period in the ON state, and thus the operation in the ON state (for example, the transfer operation) is not performed. This gap occurs depending on the number of times of switching, and thus in a case where the switching between ON and OFF frequently occurs, the gap period possibly increases, and the utilization efficiency of the time resource possibly decreases.

Further, for example, as described above, a gap occurs between the time when NCR receives an indication to be turned OFF and the time when NCR is turned OFF in accordance with the indication. This gap is not a period in the OFF state, and an operation in an ON state (for example, a transfer operation) is possibly partially performed. Thus, interference is possibly caused by the radiation of unnecessary radio waves. This gap occurs depending on the number of times of switching, and thus in a case where the switching between ON and OFF occurs frequently, the gap period possibly increases, and the period in which interference is caused by the radiation of unnecessary radio waves possibly increases.

Thus, in Proposal 5, a method for limiting the number of times of switching between ON and OFF will be described.

### Proposal 5-1

In Proposal 5-1, the number of times of switching between ON and OFF in a specific time interval is defined. For example, the number of times of switching between ON and OFF may be the maximum number of switching points between ON and OFF. For example, the number of times of switching between ON and OFF may be the maximum number of the sum of the switching points from ON to OFF and the switching points from OFF to ON.

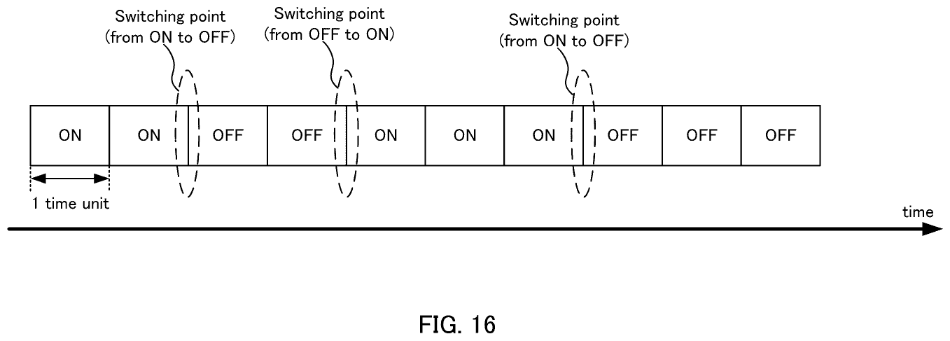

FIG. 16 is a diagram illustrating exemplary switching points. FIG. 16 illustrates ON periods, OFF periods, and switching points between an ON period and an OFF period. In the example of FIG. 16, there are two switching points where the state switches from ON to OFF, and one switching point where the state switches from OFF to ON.

Note that it is expected to switch from OFF to ON after switching from ON to OFF. Thus, as a variation, the number of times of switching between ON and OFF defined in a specific time interval may be the maximum number of switching points where the state switches from ON to OFF. In other words, the number of switching points where the state switches from OFF to ON need not be included.

Alternatively, in another variation, the number of times of switching between ON and OFF defined in a specific time interval may be the maximum number of switching points where the state switches from OFF to ON. In other words, the number of switching points where the state switches from ON to OFF need not be included.

Note that the specific time interval may be defined in advance, may be configured, or may be the subject of the capability of NCR. For example, in a case where a periodic ON-OFF pattern is indicated, the specific time interval may be determined based on the periodic ON-OFF pattern. For example, the specific time interval may be a period of a periodic ON-OFF pattern, may be an integer multiple of the period of the periodic ON-OFF pattern, or may be an interval obtained by a specific operation on the period of the periodic ON-OFF pattern.

Further, the number related to the switching between ON and OFF in Proposal 5-1 (for example, the maximum number of switching points between ON and OFF) may be defined in advance, may be configured, or may be the subject of the capability of NCR.

### Proposal 5-2

In Proposal 5-2, as in Proposal 4, the number related to the gap period is defined in a specific time interval when a gap period exists between the ON period and the OFF period. The number related to the gap period may be the maximum number of gap periods. For example, the maximum number of gap periods may be the maximum number of the sum of the number of gap periods provided during the transition from the ON period to the OFF period and the number of gap periods provided during the transition from the OFF period to the ON period.

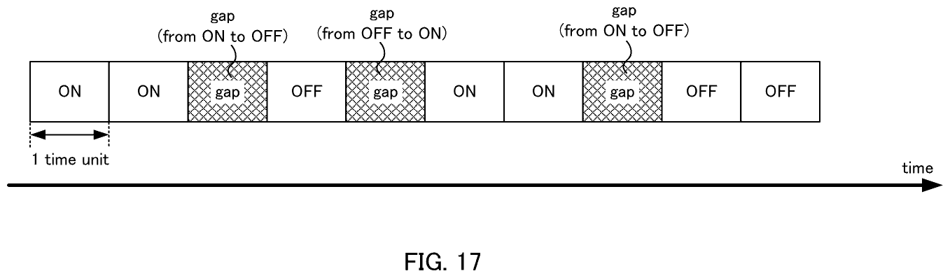

FIG. 17 is a diagram illustrating an example of a pattern including a gap period. FIG. 17 illustrates ON periods, OFF periods, and gap periods between an ON period and an OFF period. In the example of FIG. 17, there are two gap periods between the switching from ON to OFF, and one gap period between the switching from OFF to ON.

Note that, it is expected to switch from OFF to ON after switching from ON to OFF. Thus, as a variation, the number related to the gap period defined in a specific time interval may be the maximum number of gap periods provided between the ON period and the OFF period. In other words, the number of gap periods provided between the OFF period and the ON period need not be included.

Alternatively, in another variation, the number related to the gap period defined in a specific time interval may be the maximum number of gap periods provided between the OFF period and the ON period. In other words, the number of gap periods provided between the ON period and the OFF period need not be included.

Note that the specific time interval may be defined in advance, may be configured, or may be the subject of the capability of NCR. For example, in a case where a periodic ON-OFF pattern is indicated, the specific time interval may be determined based on the periodic ON-OFF pattern. For example, the specific time interval may be a period of a periodic ON-OFF pattern, an integer multiple of the period of the periodic ON-OFF pattern, or an interval obtained by a specific operation on the period of the periodic ON-OFF pattern.

Further, the number related to the gap period (for example, the maximum number of gap periods) in Proposal 5-1 may be defined in advance, may be configured, or may be the subject of the capability of NCR.

As described above, Proposal 5 has shown a method for limiting the number of times of switching between ON and OFF. Accordingly, it is possible to avoid an increase in the duration of the gap due to frequent switching between ON and OFF, and to avoid a decrease in the utilization efficiency of time resources. Further, it is possible to suppress the increase of the periods in which interference is caused by the radiation of unnecessary radio waves due to increasing of the gap periods.

### Capability of NCR

In NCR, a capability (for example, capability information) may be defined. The capability defined for the NCR may be the same as or different from the capability defined for the UE. For example, the capabilities defined for the NCR may include at least one or some of the capabilities defined for the UE. Further, the capabilities defined for the UE may include at least one or some of the capabilities defined for the NCR. Further, at least one or some of the capabilities defined for the UE may implicitly or explicitly indicate at least one or some of the capabilities defined for the NCR.

For example, the following capabilities may be defined for NCR.
Whether ON-OFF control of NCR-Fwd is supported
Time required for switching from ON to OFF in NCR
Time required for switching from OFF to ON in NCR
Whether a gap period between the ON period and the OFF period is supported
The number of times of switching from ON to OFF per specific time supported by NCR (for example, the maximum number supported)
The number of gap periods per specific time supported by NCR (for example, the maximum number supported)
Whether the operation described in each of the above proposals is possible.

Note that the time required for switching from ON to OFF (or from OFF to ON) in the capability may be the maximum value or the minimum value of the time required for switching in NCR. Alternatively, the time required for this switching may be defined for each power (transmission power) in the ON period.

For example, each of the above-described proposals may be applied in a case where the function corresponding to the proposal is supported by NCR and/or in a case where the function corresponding to the proposal is activated by a parameter of a higher layer.

Note that, in the above-described embodiment, turning “ON” may be read as being active, valid, enabled, activated, or the like, and turning “OFF” may be read as being inactive, invalid, disabled, sleep, or the like. The term “signal” may be read as information, control information, indication, or the like.

Note that, in each of the proposals described above, an example has been described in which a period in which NCR is ON (ON period), a period in which NCR is OFF (OFF period), and a gap period are present, but the present disclosure is not limited thereto. For example, a period that is neither an ON period, an OFF period, nor a gap period may be configured. For example, this period may be referred to as a Soft period. The Soft period may be configured as any of the ON period, the OFF period, and the gap period by the control information received by NCR. Alternatively, at least a part of the Soft period may be replaced with a gap period explicitly or implicitly, or may be used as a transient period.

### Apparatus Configuration

Next, an exemplary functional configuration of base station 100 and terminal 200 that execute the processing and operations described so far will be described. Base station 100 and terminal 200 may have functions for implementing the embodiment described above. Note that base station 100 and terminal 200 may each have only some of the functions described in the embodiment.

### Base Station

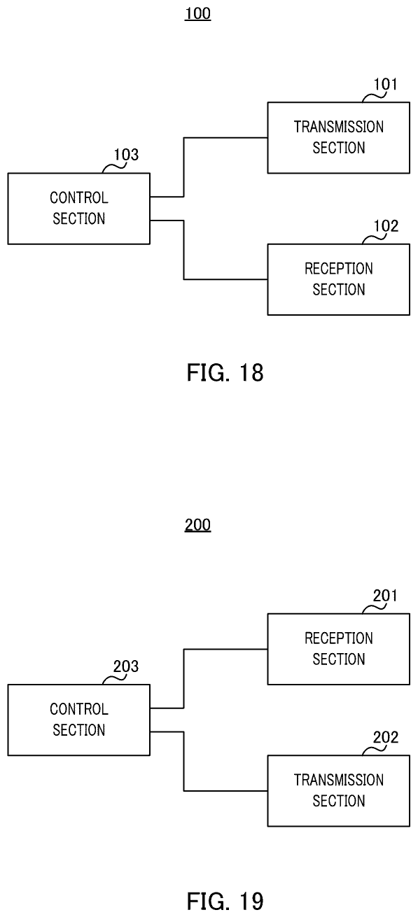

FIG. 18 is a block diagram illustrating an exemplary configuration of base station 100 according to an embodiment of the present disclosure. The base station includes, for example, transmission section 101, reception section 102, and control section 103. Base station 100 communicates with terminal 200 (see FIG. 18) by radio. Note that, transmission section 101 and reception section 102 may be collectively referred to as a communication section.

Transmission section 101 transmits the DL signal to terminal 200. For example, transmission section 101 transmits a DL signal under the control of control section 103. For example, the DL signal may include information indicating scheduling related to signal transmission of terminal 200 (for example, UL grant), control information of a higher layer, and the like.

For example, transmission section 101 transmits various control signals (such as control signals in the RRC layer), reference signals, data signals, and the like as DL signals to terminal 200 and/or relay apparatus 300. Transmission section 101 transmits, for example, various signals, channels, configuration information, control information, and the like described in the above embodiment to terminal 200 as DL signals.

For example, transmission section 101 transmits information related to the control of terminal 200 and/or information related to the control of relay apparatus 300, which are generated by control section 103, to terminal 200. Further, transmission section 101 transmits the data signal generated by control section 103 to terminal 200.

Reception section 102 receives a UL signal transmitted from terminal 200. For example, reception section 102 receives a UL signal under the control of control section 103. Further, reception section 102 may receive a UL signal transmitted from relay apparatus 300.

For example, reception section 102 receives, as a UL signal, a signal including terminal capability information (for example, UE capability) of terminal 200, various control signals, reference signals, data signals, and the like from terminal 200. Further, reception section 102 may receive a signal including capability information of relay apparatus 300 (for example, the capability of NCR).

Control section 103 controls the overall (communication) operation of base station 100, including the transmission processing in transmission section 101 and the reception processing in reception section 102.

For example, control section 103 acquires information such as data and control information from a higher layer and outputs the information to transmission section 101. Further, control section 103 outputs the data and control information received from reception section 102 to a higher layer.

For example, control section 103 allocates resources for the transmission and reception of DL signals and/or resources for the transmission and reception of UL signals based on signals (for example, data, control information, and the like) received from terminal 200 and/or data and control information acquired from a higher layer. Information on the allocated resource may be included in control information to be transmitted to terminal 200.

Control section 103 executes operations other than the transmission and reception described in the above embodiment (the operations may be executed by transmission section 101 and/or reception section 102).

For example, control section 103 may generate control information related to the transfer operation of relay apparatus 300. Further, control section 103 may perform resource allocation of the resource to be allocated to relay apparatus 300.

### Terminal

FIG. 19 is a block diagram illustrating an exemplary configuration of terminal 200 according to an embodiment of the present disclosure. Terminal 200 includes, for example, reception section 201, transmission section 202, and control section 203. Terminal 200 communicates with, for example, base station 100 (see FIG. 17) by radio. Note that, reception section 201 and transmission section 202 may be collectively referred to as a communication section.

Reception section 201 receives a DL signal transmitted from base station 100. For example, under the control of control section 203, reception section 201 receives a DL signal.

For example, reception section 201 receives various control signals, reference signals, data signals, and the like from base station 100 as DL signals. Reception section 201 receives, for example, various signals, channels, configuration information, control information, and the like described in the above embodiment as DL signals from base station 100.

For example, reception section 201 receives a signal from base station 100.

Transmission section 202 transmits a UL signal to base station 100. For example, transmission section 202 transmits a UL signal under the control of control section 203.

For example, transmission section 202 transmits, as a UL signal, a signal including information on the processing capability of terminal 200, various control signals, reference signals, data signals, and the like to base station 100.

Control section 203 controls the overall (communication) operation of terminal 200, including the reception processing in reception section 201 and the transmission processing in transmission section 202.

For example, control section 203 acquires information such as data and control information from a higher layer and outputs the information to transmission section 202. Further, control section 203 outputs, for example, data and control information received from reception section 201 to a higher layer.

Control section 203 executes operations other than the transmission and reception described in the above embodiment (note that the operations may be executed by reception section 201 and/or transmission section 202).

### Relay Apparatus

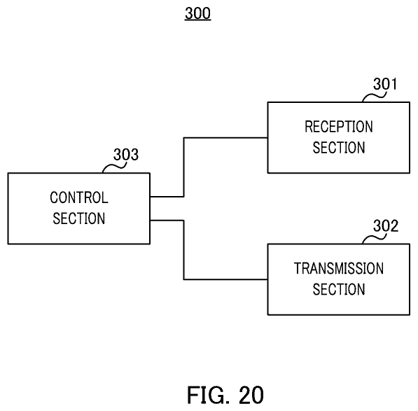

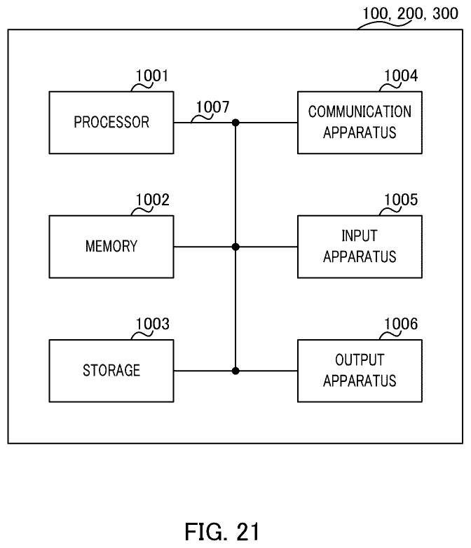

FIG. 20 is a block diagram illustrating an exemplary configuration of relay apparatus 300 according to the embodiment of the present disclosure. Relay apparatus 300 corresponds to an example of NCR. Relay apparatus 300 includes, for example, reception section 301, transmission section 302, and control section 303. Relay apparatus 300 communicates with, for example, base station 100 (see FIG. 18) and terminal 200 (see FIG. 19) by radio. Note that, reception section 301 and transmission section 302 may be collectively referred to as a communication section.

Reception section 301 receives a DL signal transmitted from base station 100. Further, reception section 301 receives a UL signal transmitted from terminal 200. For example, reception section 301 receives a DL signal and a UL signal under the control of control section 303. Note that the signal to be received may include a signal addressed to base station 100, a signal addressed to terminal 200, and a signal addressed to relay apparatus 300.

Transmission section 302 transmits the UL signal which is received from terminal 200 and is addressed to base station 100, to base station 100. Further, transmission section 302 transmits the DL signal which is received from base station 100 and is addressed to terminal 200, to terminal 200. For example, transmission section 302 transmits the UL signal under the control of control section 303.

Control section 303 controls the overall (communication) operation of relay apparatus 300, including the reception processing in reception section 301 and the transmission processing in transmission section 302.

For example, control section 303 acquires information such as data and control information from a higher layer and outputs the information to transmission section 302. Further, control section 303 outputs, for example, data and control information received from reception section 301 to a higher layer.

Control section 303 executes operations other than the transmission and reception described in the above embodiment (note that the operations may be executed by reception section 301 and/or transmission section 302).

Further, in FIG. 20, a configuration is illustrated in which one of each of reception section 301, transmission section 302, and control section 303 is included, but the present disclosure is not limited thereto. For example, as described above, relay apparatus 300 (for example, NCR 300) includes two functional entities: NCR-MT, which performs communication in the C-link; and NCR-Fwd, which performs communication in the access link and the backhaul link. Therefore, relay apparatus 300 may include a reception section, a transmission section, and a control section for each of NCR-MT and NCR-Fwd. Further, relay apparatus 300 may include a reception section, a transmission section, and a control section for each communication of the C-link, the access link, and the backhaul link.

Note that relay apparatus 300 (for example, NCR) in the present disclosure may be an example of a communication apparatus. Further, relay apparatus 300 in the present disclosure may be referred to by another name such as a transfer apparatus. Further, relay apparatus 300 in the present disclosure may be replaced with terminal 200 (for example, UE). For example, relay apparatus 300 may be regarded as terminal 200 having a transfer function (or a relay function).

### Summary of Embodiment

According to an embodiment of the present disclosure, a communication apparatus is provided, the communication apparatus including: a control section that configures, in a case where a state related to a transfer operation executed by the communication apparatus between a base station and a terminal is switched to a first state, a specific period before a period of the first state, and switches the state to the first state; and a communication section that performs transmission or reception of a signal related to transfer in accordance with the first state.

With the above configuration, the state (for example, ON state or OFF state) related to the transfer operation is appropriately changed in the specific period, and thus, the appropriate relay operation (transfer operation) can be controlled.

In the present communication apparatus, the control section configures, in a case where an indication indicating the first state is received, the specific period between a time at which the indication is received and a time at which the period of the first state is started.

With the above configuration, the state related to the transfer operation is appropriately changed in the specific period configured between the time at which the indication is received and the time at which the state based on the indication is started, and thus, an appropriate relay operation (transfer operation) can be controlled.

In the present communication apparatus, the control section configures, in a case of switching from a second state different from the first state to the first state, the specific period between a period of the second state and the period of the first state, and the specific period is defined based on a time required for switching from the second state to the first state.

With the above configuration, when the state related to the transfer operation is changed from one state to another state, the state related to the transfer operation is appropriately changed in the specific period configured between the one state to another state, and thus, an appropriate relay operation (transfer operation) can be controlled.

In the present communication apparatus, the control section switches the state from the second state to the first state based on information indicating a temporal arrangement of the period of the first state, the specific period, and the period of the second state.

With the above configuration, it is possible to efficiently perform an indication to switch the state related to the transfer operation.

In the present communication apparatus, the control section controls the number of times of switching from the second state to the first state based on information on a limitation on the number of times of switching from the second state to the first state.

With the above configuration, it is possible to suppress the number of times the state related to the transfer operation is switched, thereby suppressing the consumption of time resources associated with the change in the state.

According to an embodiment of the present disclosure, a communication method is provided in which, in a case where a communication apparatus switches a state related to a transfer operation executed by the communication apparatus between a base station and a terminal to a first state, the communication apparatus configures a specific period before a period of the first state, switches the state to the first state, and performs transmission or reception of a signal related to the transfer in accordance with to the first state.

With the above configuration, the state (for example, ON state or OFF state) related to the transfer operation is appropriately changed in the specific period, and thus, an appropriate relay operation (transfer operation) can be controlled.

Note that relay apparatus 300 (for example, NCR) in the present disclosure may be read as a base station. In this case, base station 100 may have the functions described above that relay apparatus 300 has. Further, relay apparatus 300 (for example, NCR) in the present disclosure may be read as a terminal. In this case, terminal 200 may have the functions described above that relay apparatus 300 has.

The present disclosure has been described above. The division of the items in the above description is not essential to the present disclosure, and matters described in two or more items may be combined and used as necessary, and a matter described in one item may be applied to a matter described in another item (as long as the maters do not contradict each other).

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

For example, a base station, a terminal, a relay apparatus (e.g., NCR), and so on according to one embodiment of the present disclosure may function as a computer that executes the processes of the radio communication method of the present disclosure. FIG. 21 is a diagram to show an example of a hardware structure of a base station, a terminal, and a relay apparatus according to one embodiment of a present disclosure. Physically, the above-described base station 100, terminal 200, and relay apparatus 300 may each be formed as a computer apparatus that includes processor 1001, memory 1002, storage 1003, communication apparatus 1004, input apparatus 1005, output apparatus 1006, bus 1007, and so on.

Note that in the present disclosure, the words such as an apparatus, a circuit, a device, a section, a unit, and so on can be interchangeably interpreted. The hardware structure of base station 100, terminal 200, and relay apparatus 300 may be configured to include one or more of apparatuses shown in the drawings, or may be configured not to include part of apparatuses.

Each function of base station 100, terminals 200, and relay apparatus 300 is implemented, for example, by allowing certain software (programs) to be read on hardware such as processor 1001 and memory 1002, and by allowing processor 1001 to perform calculations to control communication via communication apparatus 1004 and control at least one of reading and writing of data in memory 1002 and storage 1003.

Processor 1001 controls the whole computer by, for example, running an operating system. Processor 1001 may be configured with a central processing unit (CPU), which includes interfaces with peripheral apparatus, control apparatus, computing apparatus, a register, and so on. For example, at least part of above-described control section 103 or control section 203, control section 303, and so on may be implemented by processor 1001.

Furthermore, processor 1001 reads programs (program codes), software modules, data, and so on from at least one of storage 1003 and communication apparatus 1004, into memory 1002, and executes various processes according to these. As for the programs, programs to allow computers to execute at least part of the operations of the above-described embodiments are used. For example, base station 100, terminal 200, and relay apparatus 300 may be implemented by control programs that are stored in memory 1002 and that operate on processor 1001, and other functional blocks may be implemented likewise. The various processes have been described to be performed by single processor 1001. However, the processes may be performed by two or more processors 1001 simultaneously or sequentially. Processor 1001 may be implemented by one or more chips. It should be noted that the program may be transmitted from a network via a telecommunication line.

Memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. Memory 1002 may be referred to as a “register,” a “cache,” a “main memory (primary storage apparatus)” and so on. Memory 1002 can store executable programs (program codes), software modules, and the like for implementing the radio communication method according to one embodiment of the present disclosure.

Storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. Storage 1003 may be referred to as “auxiliary storage apparatus.” The above recording medium may be a database including memory 1002 and/or storage 1003, a server, or any other appropriate medium.

Communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. Communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmission section 101, transmission section 202, transmission section 302, reception section 102, reception section 201, reception section 301, and the like, may be realized by communication apparatus 1004. Communication apparatus 1004 may be implemented by physically or logically divided into a transmission section and reception section.

Input apparatus 1005 is an input device that receives input from the outside (for example, a keyboard, a mouse, a microphone, a switch, a button, a sensor, and so on). Output apparatus 1006 is an output device that allows sending output to the outside (for example, a display, a speaker, a Light Emitting Diode (LED) lamp, and so on). Note that input apparatus 1005 and output apparatus 1006 may be provided in an integrated structure (for example, a touch panel).

Furthermore, these types of apparatus, including processor 1001, memory 1002, and others, are connected by bus 1007 for communicating information. Bus 1007 may be formed with a single bus, or may be formed with buses that vary between pieces of apparatus.

Also, base station 100, terminals 200, and relay apparatus 300 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Supplement to Embodiment

While the embodiment of the present disclosure has been described above, the disclosed invention is not limited to such an embodiment, and a person skilled in the art would understand various variations, modifications, alternatives, substitutions, and the like. Specific numerical examples have been used in the description to facilitate understanding of the invention, but unless otherwise noted, these numbers are merely examples and any suitable values may be used. The division of the items in the above description is not essential to the present disclosure, and matters described in two or more items may be combined and used as necessary, and matters described in one item may be applied to matters described in another item (as long as they do not contradict each other). The boundaries of the functional sections and processing sections in the functional block diagram do not necessarily correspond to the boundaries of physical components. The operations of a plurality of functional sections may be performed physically by one component, or the operation of one functional section may be performed physically by a plurality of components. The processing procedures described in the embodiment may be performed in a different order as long as there is no contradiction. For convenience of description of the processing, base station 100, terminal 200, and relay apparatus 300 have been described using functional block diagrams, but such apparatuses may be implemented in hardware, software, or a combination thereof. Software that operates on a processor included in base station 100 according to an embodiment of the present disclosure, software that operates on a processor included in terminal 200 according to an embodiment of the present disclosure, and software that operates on a processor included in relay apparatus 300 according to an embodiment of the present disclosure may each be stored in any suitable storage medium, such as a random access memory (RAM), a flash memory, a read-only memory (ROM), an erasable programmable read-only memory (EPROM), an electrically erasable programmable read-only memory (EEPROM), a register, a hard disk (HDD), a removable disk, a CD-ROM, a database, a server, or the like.

### Notification and Signaling of Information

Notification of information is by no means limited to the embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

### Application System

The embodiments illustrated in the present disclosure may be applied to Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New Radio (NR), New radio access (NX), Future generation radio access (FX), W-CDMA (registered trademark), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) for application.

### Processing Procedure and the Like

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

### Operation of Base Station

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these. According to the above, a case is described in which there is a single network node other than the base station. However, a combination of multiple other network nodes may be considered (e.g., MME and S-GW).

### Direction of Input and Output

The information or signals described in this disclosure may be output from a higher layer (or lower layer) to a lower layer (or higher layer). The information or signals may be input or output through multiple network nodes.

### Handling of Input and Output Information and the Like

The input or output information may be stored in a specific location (e.g., memory) or managed using management tables. The input or output information may be overwritten, updated, or added. The information that has been output may be deleted. The information that has been input may be transmitted to another apparatus.

### Determination Method

A decision or a determination in an embodiment of the present invention may be realized by a value (0 or 1) represented by one bit, by a boolean value (true or false), or by comparison of numerical values (e.g., comparison with a predetermined values).

### Variations and the Like of Aspects

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### Software

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

### Information and Signals

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

### System and Network

As used in the present disclosure, the terms “system” and “network” are used interchangeably.

### Names of Parameters and Channels

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

### Base Station

In the present disclosure, the terms such as a “base station (BS),” a “radio base station,” a “fixed station,” a “NodeB,” an “eNB (eNodeB),” a “gNB (gNodeB),” an “access point,” a “transmission point,” a “reception point,” a “transmission/reception point,” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station.

### Mobile Station

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

### Base Station/Mobile Station

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on. The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, the base station in the present disclosure may be interpreted as a terminal. For example, an embodiment of the present disclosure may be applied to the structure that replaces a communication between a base station and a terminal with a communication between a plurality of terminals (for example, which may be referred to as “Device-to-Device (D2D),” “Vehicle-to-Everything (V2X),” and the like). In this case, terminals 200 may have the functions of base stations 100 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the terminal in the present disclosure may be interpreted as base station. In this case, base station 100 may have the functions of terminal 200 described above.

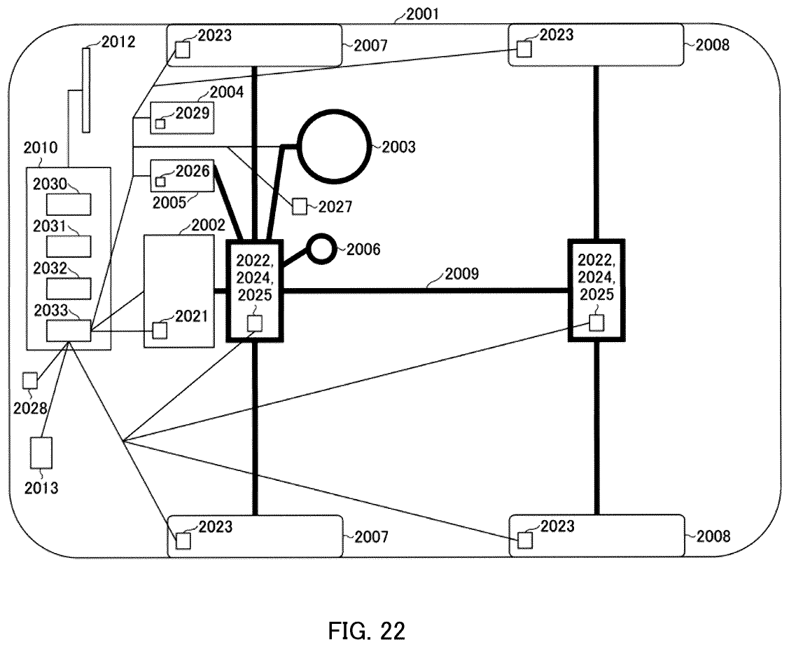

FIG. 22 shows an example of a configuration of vehicle 2001. As shown in FIG. 22, vehicle 2001 includes drive unit 2002, steering unit 2003, accelerator pedal 2004, brake pedal 2005, shift lever 2006, front wheel 2007, rear wheel 2008, axle 2009, electronic control unit 2010, various sensors 2021 to 2029, information service unit 2012, and communication module 2013. The aspects/embodiments described in the present disclosure may be applied to a communication device mounted in vehicle 2001, and may be applied to, for example, communication module 2013.

Drive unit 2002 may include, for example, an engine, a motor, and a hybrid of an engine and a motor. Steering unit 2003 includes at least a steering wheel and is configured to steer at least one of the front wheel or the rear wheel, based on the operation of the steering wheel operated by the user.

Electronic control unit 2010 includes microprocessor 2031, memory (ROM, RAM) 2032, and communication port (IO port) 2033. Electronic control unit 2010 receives signals from the various sensors 2021 to 2029 provided in vehicle 2001. Electronic control unit 2010 may be referred to as an ECU (Electronic control unit).

Signals from various sensors 2021 to 2029 include a current signal from current sensor 2021 which senses the current of the motor, a front or rear wheel rotation signal acquired by revolution sensor 2022, a front or rear wheel pneumatic signal acquired by pneumatic sensor 2023, a vehicle speed signal acquired by vehicle speed sensor 2024, an acceleration signal acquired by acceleration sensor 2025, a stepped-on accelerator pedal signal acquired by accelerator pedal sensor 2029, a stepped-on brake pedal signal acquired by brake pedal sensor 2026, an operation signal of a shift lever acquired by shift lever sensor 2027, and a detection signal, acquired by object detection sensor 2028, for detecting an obstacle, a vehicle, a pedestrian, and the like.

Information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

Information service unit 2012 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

Driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, driving support system unit 2030 transmits and receives various types of information via communication module 2013 to realize a driving support function or an autonomous driving function.

Communication module 2013 may communicate with microprocessor 2031 and components of vehicle 2001 via a communication port. For example, communication module 2013 transmits and receives data via communication port 2033, to and from drive unit 2002, steering unit 2003, accelerator pedal 2004, brake pedal 2005, shift lever 2006, front wheel 2007, rear wheel 2008, axle 2009, microprocessor 2031 and memory (ROM, RAM) 2032 in electronic control unit 2010, and sensors 2021 to 2029 provided in vehicle 2001.

Communication module 2013 is a communication device that can be controlled by microprocessor 2031 of electronic control unit 2010 and that is capable of communicating with external devices. For example, various kinds of information are transmitted to and received from external devices through radio communication. Communication module 2013 may be internal to or external to electronic control unit 2010. The external devices may include, for example, a base station, a mobile station, or the like.

Communication module 2013 may transmit at least one of signals from various sensors 2021 to 2029 described above input to electronic control unit 2010, information obtained based on the signals, and information based on an input from the outside (a user) obtained via information service unit 2012, to the external apparatus via radio communication. Electronic control unit 2010, various sensors 2021 to 2029, information service unit 2012, and the like may be referred to as input units that receive input. For example, the PUSCH transmitted by communication module 2013 may include information based on the input.

Communication module 2013 receives various types of information (traffic information, signal information, inter-vehicle information, etc.) transmitted from the external devices and displays the received information on information service unit 2012 provided in vehicle 2001. Information service unit 2012 may be referred to as an output unit that outputs information (for example, outputs information to devices, such as a display and a speaker, based on the PDSCH received by communication module 2013 (or data/information decoded from the PDSCH)). In addition, communication module 2013 stores the various types of information received from the external devices in memory 2032 available to microprocessor 2031. Based on the information stored in memory 2032, microprocessor 2031 may control drive unit 2002, steering unit 2003, accelerator pedal 2004, brake pedal 2005, shift lever 2006, front wheel 2007, rear wheel 2008, axle 2009, sensors 2021 to 2029 etc., mounted in vehicle 2001.

### Meaning and Interpretation of Terms

As used herein, the term “determining” may encompasses a wide variety of actions. For example, “determining” may be regarded as judging, calculating, computing, processing, deriving, investigating, looking up or search inquiry (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing, and the like. That is, “determining” may be regarded as a certain type of action related to determining. Also, “determining” may be replaced with “assuming,” “expecting,” “considering,” and the like.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

### Reference Signal

A reference signal may be abbreviated as an “RS,” and may be referred to as a “pilot” and so on, depending on which standard applies.

### Meaning of “Based On”

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

### “First” and “Second”

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

### Means

“Means” included in the configuration of each of the above apparatuses may be replaced by “parts,” “circuits,” “devices,” etc.

### Open Form

In the case where the terms “include,” “including” and variations thereof are used in the present disclosure, these terms are intended to be comprehensive in the same way as the term “comprising.” Further, the term “or” used in the present specification is not intended to be an “exclusive or.”

### Time Units such as TTI, Frequency Units Such as RB, and Radio Frame Configuration

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “Transmission Time Interval (TTI),” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.” Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in LTE Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

### Maximum Transmit Power

The “maximum transmit power” described in the present disclosure may mean a maximum value of the transmit power, the nominal UE maximum transmit power, or the rated UE maximum transmit power.

### Article

In the present disclosure, where an article is added by translation, for example “a”, “an”, and “the”, the disclosure may include that the noun following these articles is plural.

### “Different”

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different.”

### Industrial Applicability

An aspect of the present disclosure is useful for radio communication systems.

### REFERENCE SIGNS LIST

10 Radio communication system
20 NG-RAN
100 Base station (gNB)
200 Terminal (UE)
300 Relay apparatus (NCR)
101, 202, 302 Transmission section
102, 201, 301 Reception section
103, 203, 303 Control section
1001 Processor
1002 Memory
1003 Storage
1004 Communication apparatus
1005 Input apparatus
1006 Output apparatus
1007 Bus

1. A communication apparatus, comprising:
a control section that configures, in a case where a state related to a transfer operation executed by the communication apparatus between a base station and a terminal is switched to a first state, a specific period before a period of the first state, and switches the state to the first state; and
a communication section that performs transmission or reception of a signal related to transfer in accordance with the first state.

2. The communication apparatus according to claim 1, wherein
the control section configures, in a case where an indication indicating the first state is received, the specific period between a time at which the indication is received and a time at which the period of the first state is started.

3. The communication apparatus according to claim 1, wherein
the control section configures, in a case of switching from a second state different from the first state to the first state, the specific period between a period of the second state and the period of the first state, and
the specific period is defined based on a time required for switching from the second state to the first state.

4. The communication apparatus according to claim 3, wherein
the control section switches the state from the second state to the first state based on information indicating a temporal arrangement of the period of the first state, the specific period, and the period of the second state.

5. The communication apparatus according to claim 3, wherein
the control section controls the number of times of switching from the second state to the first state based on information on a limitation on the number of times of switching from the second state to the first state.

6. A communication method, comprising:
configuring, by a communication apparatus, in a case where a state related to a transfer operation executed by the communication apparatus between a base station and a terminal is switched to a first state, a specific period before a period of the first state, and switching the state to the first state; and
performing, by the communication apparatus, transmission or reception of a signal related to transfer in accordance with the first state.
